(19) United States
(12) Patent Application Publication
(10) Pub. No.: US 2026/0194290 A1
(43) Pub. Date: Jul. 9, 2026

(54) COATING LAYER INCLUDING BIO-BASED RESIN AND HOME APPLIANCE INCLUDING THE SAME

(71) Applicant: SAMSUNG ELECTRONICS CO., LTD., Suwon-si (KR)

(72) Inventors: Jungmin CHOI, Suwon-si (KR); Choongkeon KIM, Suwon-si (KR); Dosoo SUNG, Suwon-si (KR); Youngdeog KOH, Suwon-si (KR)

(73) Assignee: SAMSUNG ELECTRONICS CO., LTD., Suwon-si (KR)

(21) Appl. No.: 19/063,735

(22) Filed: Feb. 26, 2025

Related U.S. Application Data
(63) Continuation of application No. PCT/KR2025/002338, filed on Feb. 18, 2025.

(30) Foreign Application Priority Data
Jan. 6, 2025 (KR) 10-2025-0001534

(51) Int. Cl. F25D 23/06; B05D 7/00; B05D 7/14; D06F 39/02

(52) U.S. Cl. CPC F25D 23/065; B05D 7/14; B05D 7/576; D06F 39/02; B05D 2507/00; B05D 2601/22; B05D 2601/28; F25D 2400/18

(57) ABSTRACT

A refrigerator may include a main body, a door connected to the main body and configured to open and close to respectively open and close the main body, and a storage compartment disposed in the main body to store food. wherein an exterior material of the main body may include: a frame including a metal material, a primer layer disposed on the frame, a base layer disposed on the primer layer and including a first bio-based resin, a clear layer disposed on the base layer and including a second bio-based resin, and the base layer and/or the clear layer may contain biomass and an inorganic additive.

### CROSS-REFERENCE TO RELATED APPLICATIONS

This application is a continuation application of International Application No. PCT/KR2025/002338 designating the United States, filed on Feb. 18, 2025, in the Korean Intellectual Property Receiving Office, which claims priority from Korean Patent Application No. 10-2025-0001534, filed on Jan. 6, 2025, in the Korean Intellectual Property Office, the disclosures of which are hereby incorporated by reference herein in their entireties.

### BACKGROUND

### Field

An embodiment of the disclosure relates to a coating layer used for a main body of a home appliance and including a bio-based resin.

### Description of Related Art

Home appliances refer to electronic and electrical devices used in the home, and may include devices, such as refrigerators, washing machines, and air conditioners that help make household chores more convenient and enhance the quality of life.

Home appliances are being manufactured to play an important role in design and environmental aspects as well as practical purposes. For example, the main body (e.g., housing) forming the exterior of a home appliance may include coating layers having various shapes so that it may be provided as an exterior material with high brightness/high contrast while ensuring chemical resistance and mechanical properties. Further, in home appliances, the coating layer formed to wrap the frame of the exterior material may minimize negative impact on the environment when manufacturing the product using eco-friendly materials. The coating layer of the exterior material may include a bio-based resin based on biomass.

As interest in the environment has increased recently, many efforts are being made in various fields to reduce carbon dioxide, which is pointed out as the main culprit of global warming. Among these, bio-based raw materials that may replace existing oil and coal resources are drawing attention.

Use of paints containing bio-based resins (e.g., biomass) as the coating layer for the exterior material of home appliances may reduce carbon dioxide emissions in the entire paint production process, as compared with general paints containing petrochemical resins, as the bio-based raw materials are plants that use carbon dioxide in the atmosphere while growing.

However, an increase in the content of the bio-based resin in the paint for the exterior material of the home appliance may weaken the chemical resistance and mechanical properties of the entire coating film.

Accordingly, there is a discussion for design of a coating layer with high brightness and high contrast that may provide aesthetics when viewed from the outside while maintaining chemical resistance and mechanical properties of the exterior material for home appliances including bio-based resins.

### SUMMARY

In accordance with the present disclosure, a refrigerator may include: a main body, a door connected to the main body and configured to open and close to respectively open and close the main body, and a storage compartment disposed in the main body to store food. wherein an exterior material of the main body may include: a frame including a metal material, a primer layer disposed on the frame, a base layer disposed on the primer layer and including a first bio-based resin, a clear layer on the base layer and including a second bio-based resin, and the base layer and/or the clear layer may contain biomass and an inorganic additive.

The inorganic additive may include silica (Si) and zirconium (Zr).

A content of the inorganic additive contained in the base layer may be 0.2 wt % to 0.6 wt % relative to a total resin weight of the base layer, and/or a content of the inorganic additive contained in the clear layer may be 0.2 wt % to 0.6 wt % relative to a total resin weight of the clear layer.

A content of the silica of the inorganic additive may be 0.1 wt % to 0.4 wt % relative to a total weight of the inorganic additive and a content of the zirconium in the inorganic additive may be 0.1 wt % to 0.2 wt % relative to a total weight of the inorganic additive.

A content of the first bio-based resin may be 10 wt % to 100 wt % relative to a total resin weight of the base layer.

A content of the second bio-based resin may be 10 wt % to 100 wt % relative to a total resin weight of the clear layer.

An average molecular weight (MW) of the first bio-based resin may be 2,000 to 5,000 g/mol, and an average molecular weight (MW) of the second bio-based resin may be 10,000 to 20,000 g/mol.

The base layer may further include a first petroleum-based resin and an average molecular weight (MW) of the first petroleum-based resin may be 5,000 to 10,000 g/mol, and the clear layer may further include a second petroleum-based resin and an average molecular weight (MW) of the second petroleum-based resin may be 1,000 to 3,000 g/mol.

A content of the first bio-based resin may be 20 wt % to 30 wt % relative to a total resin weight of the base layer and/or a content of the second bio-based resin may be 20 wt % to 30 wt % relative to a total resin weight of the clear layer, and a content of the inorganic additive in the base layer may be 0.2 wt % to 0.4 wt % relative to the total resin weight of the base layer and/or a content of the inorganic additive in the clear layer may be 0.2 wt % to 0.4 wt % relative to the total resin weight of the clear layer.

A content of the first bio-based resin may be 55 wt % to 65 wt % relative to a total resin weight of the base layer or a content of the second bio-based resin may be 55 wt % to 65 wt % relative to a total resin weight of the clear layer, and a content of the inorganic additive in the base layer may be 0.3 wt % to 0.5 wt % relative to the total resin weight of the base layer, and/or a content of the inorganic additive in the clear layer may be 0.3 wt % to 0.5 wt % relative to the total resin weight of the clear layer.

A content of the first bio-based resin may be 100 wt % relative to a total resin weight of the base layer or a content of the second bio-based resin may be 100 wt % relative to a total resin weight of the clear layer, and a content of the inorganic additive in the base layer may be 0.4 wt % to 0.6 wt % relative to the total resin weight of the base layer and/or a content of the inorganic additive in the clear layer may be 0.4 wt % to 0.6 wt % relative to the total resin weight of the clear layer.

A content of the first bio-based resin may be 20 wt % to 25 wt % relative to a total resin weight of the base layer, and a content of the second bio-based resin may be 25 wt % to 30 wt % relative to the total resin weight of the clear layer.

The base layer and/or the clear layer may include a curing agent, a defoamer, and a catalyst, a content of the curing agent in the base layer may be 5.0 wt % to 10.0 wt % relative to the total resin weight of the base layer and/or a content of the curing agent in the clear layer may be 5.0 wt % to 10.0 wt % relative to the total resin weight of the clear layer, a content of the defoamer in the base layer may be about 0.2 wt % to 0.5 wt % relative to the total resin weight of the base layer and/or a content of the defoamer in the clear layer may be about 0.2 wt % to 0.5 wt % relative to the total resin weight of the clear layer, and a content of the catalyst in the base layer may be about 0.5 wt % to 1.0 wt % relative to the total resin weight of the base layer and/or a content of the catalyst in the clear layer may be about 0.5 wt % to 1.0 wt % relative to the total resin weight of the clear layer.

In accordance with the present disclosure, a home appliance may include: an exterior material including: a frame including a metal material, a primer layer disposed on the frame, a base layer disposed on the primer layer and including a first bio-based resin, and a clear layer disposed on the base layer and including a second bio-based resin, wherein the base layer and/or the clear layer include an inorganic additive, and a content of the inorganic additive in the base layer may be 0.2 wt % to 0.6 wt % relative to a total resin weight of the base layer and/or a content of the inorganic additive in the clear layer is 0.2 wt % to 0.6 wt % relative to a total resin weight of the clear layer.

The inorganic additive may include silica (Si) and zirconium (Zr).

A content of the silica of the inorganic additive may be 0.1 wt % to 0.4 wt % relative to a total weight of the inorganic additive and a content of the zirconium of the inorganic additive may be 0.1 wt % to 0.2 wt % relative to a total weight of the inorganic.

A content of the first bio-based resin may be 20 wt % to 30 wt % relative to the total resin weight of the base layer and/or a content of the second bio-based resin may be 20 wt % to 30 wt % relative to the total resin weight of the clear layer, and the content of the inorganic additive in the base layer may be 0.2 wt % to 0.4 wt % relative to a total resin weight of the base layer and/or a content of the inorganic additive in the clear layer may be 0.2 wt % to 0.4 wt % relative to the total resin weight of the clear layer.

In accordance with the present disclosure, a washing machine may include: a main body including an opening formed in a front surface thereof, a tub disposed in the main body and configured to receive water, and a rotatable drum disposed in the tub, wherein an exterior material of the main body may include: a frame including a metal material, a primer layer disposed on the frame, a base layer disposed on the primer layer and including a first bio-based resin, and a clear layer disposed on the base layer and including a second bio-based resin, and the base layer and/or the clear layer include an inorganic additive, and a content of the inorganic additive in the base layer may be 0.2 wt % to 0.6 wt % relative to a total resin weight of the base layer and/or a content of the inorganic additive in the clear layer is 0.2 wt % to 0.6 wt % relative to a total resin weight of the clear layer.

The inorganic additive may include silica (Si) and zirconium (Zr).

A content of the silica in the base layer may be 0.1 wt % to 0.4 wt % relative to the total resin weight of the base layer and a content of the zirconium in the base layer may be 0.1 wt % to 0.2 wt % relative to a total weight of the base layer, and/or a content of the silica in the clear layer may be 0.1 wt % to 0.4 wt % relative to the total resin weight of the clear layer and a content of the zirconium in the clear layer may be 0.1 wt % to 0.2 wt % relative to a total weight of the clear layer.

A content of the first bio-based resin may be 20 wt % to 30 wt % relative to the total resin weight of the base layer and/or a content of the second bio-based resin may be 20 wt % to 30 wt % relative to the total resin weight of the clear layer, and the content of the inorganic additive in the base layer may be 0.2 wt % to 0.4 wt % relative to a total resin weight of the base layer, and/or a content of the inorganic additive in the clear layer may be 0.2 wt % to 0.4 wt % relative to the total resin weight of the clear layer.

The disclosure is not limited to the foregoing embodiments but various modifications or changes may rather be made thereto without departing from the spirit and scope of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a refrigerator according to an embodiment of the disclosure;

FIG. 2 is a block diagram illustrating a configuration of a refrigerator according to an embodiment of the disclosure;

FIG. 3 is a cross-sectional view of a portion of a main body forming the exterior of a refrigerator according to an embodiment of the disclosure;

FIGS. 4A and 4B are views illustrating results of a chemical resistance test on a coating layer of a general home appliance (e.g., a refrigerator or a washing machine) under a specific condition;

FIG. 5 is a view illustrating results of a chemical resistance test on a coating layer of a home appliance (e.g., a refrigerator or a washing machine) under a specific condition according to an embodiment of the disclosure;

FIG. 6A is a perspective view illustrating an outer appearance of a washing machine according to an embodiment of the disclosure; and

FIG. 6B is a side cross-sectional view illustrating a washing machine according to an embodiment of the disclosure.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

In the disclosure, the term “and/or” may denote a combination(s) of a plurality of related components as listed or any of the components.

In the disclosure, such terms as “1st” and “2nd,” or “first” and “second” may be used to simply distinguish a corresponding component from another, and does not limit the components in other aspect (e.g., importance or order).

In the disclosure, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The refrigerator according to an embodiment may include a main body.

The “main body” may include an inner case, an outer case disposed outside the inner case, and an insulator provided between the inner case and the outer case.

The “inner case” may include at least one of a case, a plate, a panel, or a liner forming a storage compartment. The inner case may be formed as a single body or may be formed by assembling a plurality of plates. The “outer case” may form the outer appearance of the main body and may be coupled to an outer side of the inner case so that the insulator is disposed between the inner case and the outer case.

The “insulator” may insulate the inside of the storage compartment and the outside of the storage compartment so that the temperature inside the storage compartment is maintained at a set appropriate temperature without being affected by the environment outside the storage compartment. According to an embodiment, the insulator may include a foam insulator. The foam insulator may be formed by injecting and foaming a urethane foam formed by mixing polyurethane and a foaming agent between the inner case and the outer case.

According to an embodiment, the insulator may further include a vacuum insulator in addition to the foam insulator, or the insulator may be composed of only a vacuum insulator instead of the foam insulator. The vacuum insulation material may include a core material and an outer cover material that accommodates the core material and seals the inside at a pressure close to vacuum or vacuum. However, the insulator is not limited to the foam insulator or the vacuum insulator, and may include various materials that may be used for insulation.

The “storage compartment” may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

The refrigerator may include one or more storage compartments. When two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a “refrigerating compartment”, a “freezing compartment”, or an “adjustable-temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a “vegetable compartment”, a “fresh compartment”, a “cooling compartment”, an “ice-making compartment”, and the like, in addition to the names “refrigerating compartment”, “freezing compartment”, and “adjustable-temperature compartment”, and the terms “refrigerating compartment”, “freezing compartment”, and “adjustable-temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The “door” may be configured to seal the storage compartment when the door is closed. Like the main body, the door may include an insulator to insulate the storage compartment when the door is closed.

According to an embodiment, the door may include a door outer plate forming a front surface of the door, a door inner plate forming a rear surface of the door and facing the storage compartment, an upper cap, a lower cap, and a door insulator provided thereinside.

A gasket may be provided on the edge of the door inner plate to seal the storage compartment by being in close contact with the front surface of the main body when the door is closed. The door inner plate may include a dyke protruding rearward to mount a door basket capable of storing an object.

According to an embodiment, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice making tray storing water, an ice maker separating ice from the ice making tray, and an ice bucket storing ice generated in the ice making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

Hereinafter, embodiments of the disclosure are described in detail with reference to the accompanying drawings.

Meanwhile, the terms “upper”, “lower”, “front”, and “rear” used in the following description are defined with respect to the drawings, and the shape and position of each component are not limited by these terms. For example, the terms “front” and “rear” below may mean the front and rear, respectively, of the refrigerator in the X direction with respect to the drawings. The terms “upper” and “lower” below may mean upper and lower, respectively, in the Z direction of the refrigerator with respect to the drawings. The terms “left” and “right” below may mean the left and right, respectively, in the Y direction of the refrigerator with respect to the drawings.

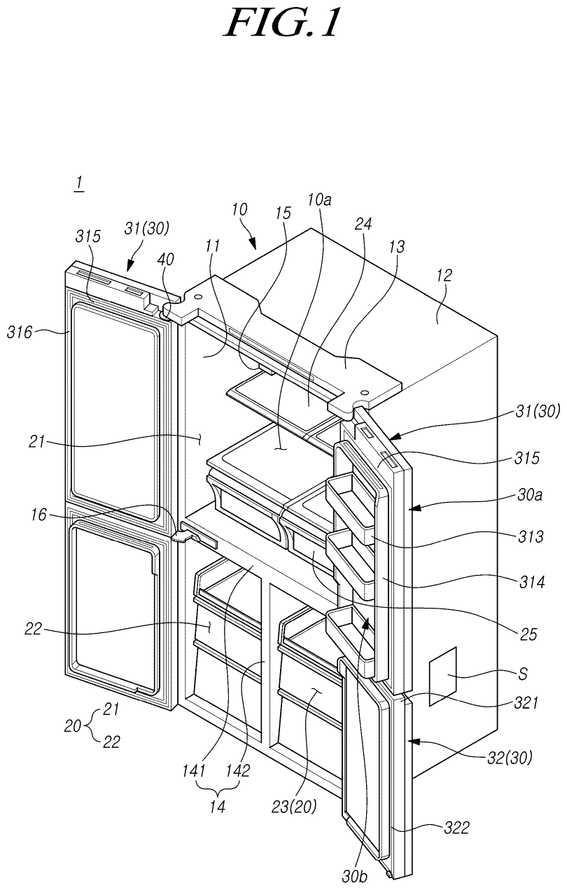

FIG. 1 is a perspective view illustrating a refrigerator according to an embodiment of the disclosure.

Referring to FIG. 1, a refrigerator 1 may include a main body 10, a storage compartment 20, a door 30, or a cold air supply device.

According to an embodiment, the storage compartment 20 may be partitioned into several spaces inside the main body 10. The door 30 may be disposed on the front surface of the main body 10 to open and close the storage compartment 20. The cold air supply device may be provided inside the main body 10 to supply cold air to, e.g., the storage compartment 20.

According to an embodiment, the main body 10 may include an inner housing 11 and/or an outer housing 12. The inner housing 11, e.g., may be provided to form an exterior of the storage compartment 20. The inner housing 11 may be integrally injection-molded with, e.g., a plastic material. The outer housing 12, e.g., may be provided to form at least a portion of the exterior of the refrigerator 1. The outer housing 12 may be formed of, e.g., a metal material having excellent durability and aesthetics. A receiving space may be formed between the inner housing 11 and the outer housing 12. A main body insulator (not shown) for insulating the storage compartment 20 may be provided in a portion of the receiving space.

According to an embodiment, the cold air supply device may generate cold air using a cooling circulation cycle for compressing, condensing, expanding, and evaporating the refrigerant.

According to an embodiment, the storage compartment 20 may be partitioned into a plurality of compartments by a partition wall 14. The storage compartment 20 may be formed by the inner housing 11 and the partition wall 14 of the main body 10. A plurality of shelves 24 or storage containers 25 may be provided inside the storage compartment 20 to store food or the like. The plurality of shelves 24 and the storage container 25 may be, e.g., removable.

According to an embodiment, the storage compartment 20 may be divided into a plurality of storage compartments 21, 22, and 23 by the partition wall 14. For example, as illustrated, the storage compartment 20 may include one first storage compartment 21 (e.g., an upper storage compartment) positioned at an upper portion, and a second storage compartments 22 (e.g., a lower storage compartment) and a third storage compartment 23 (e.g., a lower storage compartment) positioned at a lower portion.

According to an embodiment, the partition wall 14 may include a first partition wall 141 and a second partition wall 142. The partition wall 14 may have, e.g., a T-shaped cross section. The first partition wall 141 may be provided horizontally to divide, e.g., the first storage compartment 21 and the second and third storage compartments 22 and 23. The second partition wall 142 may be provided vertically to divide, e.g., the second storage compartment 22 and the third storage compartment 23. The second partition wall 142 may be formed to protrude downward from, e.g., the first partition wall 141. The illustrated second partition wall 142 is formed to protrude from the center of the first partition wall 141, but the disclosure is not limited thereto, and the sizes of the second storage compartment 22 and the third storage compartment 23 may vary depending on the position of the second partition wall 142.

The first storage compartment 21 of the illustrated storage compartment 20 may be used as a refrigerating chamber, and the second and third storage compartments 22 and 23 may be used as freezing chambers, but the disclosure is not limited thereto, and the position and number of each of the refrigerating chamber and the freezing chamber may vary depending on the user's needs.

According to an embodiment, the number, size, or shape of the storage compartment 20 may vary depending on the shape or position of the partition wall 14. The freezing chamber may be maintained at about minus 20 degrees Celsius, and the refrigerating chamber may be maintained at about 3 degrees Celsius. The storage compartment 20 may be insulated by, e.g., a partition wall 14.

According to an embodiment, the storage compartment 20 may be partitioned left and right by one vertical partition wall. Here, the vertical partition wall may be formed so that one end is in contact with the upper portion of the inner housing 11 and the other end is in contact with the lower portion of the inner housing 11. The size of the storage compartment 20 partitioned left and right may vary depending on the position of the vertical partition wall. For example, the storage compartment 20 having the vertical partition wall provided in the middle and partitioned left and right may be provided in mirror symmetry. According to an embodiment, there may be a plurality of vertical partition walls. When there are a plurality of vertical partition walls, three or more storage compartments 20 may be provided in the left-right direction.

According to an embodiment, the storage compartment 20 may be partitioned up and down only by one horizontal partition wall. In other words, the storage compartment 20 may be partitioned into two, e.g., the upper storage compartment and the lower storage compartment. Here, the horizontal partition wall may be formed so that one end thereof is in contact with the left portion of the inner housing 11 and the other end thereof is in contact with the right portion of the inner housing 11. The size of the storage compartment 20 partitioned up and down may vary depending on the position of the horizontal partition wall. According to an embodiment, there may be a plurality of horizontal partition walls. When there are a plurality of horizontal partition walls, three or more storage compartments 20 may be provided in the up-down direction. In addition to the above-described embodiment, a plurality of storage compartments 20 of various types may be configured according to the shape and number of partition walls 14.

According to an embodiment, the door 30 may include a first door 31 (e.g., an upper door) or a second door 32 (e.g., a lower door) as illustrated. The door 30 may be provided to open and close, e.g., the opening 10a of the main body 10. For example, a pair of first doors 31 (e.g., double door type) may be provided to open and close the first storage compartment 21. A pair of second doors 32 (e.g., double door type) may be provided to open or close, e.g., the second storage compartment 22 or the third storage compartment 23. Further, the number and shape of the doors 30 may vary depending on the number and shape of the storage compartment 20, and the door 30 may be configured in a sliding manner as well as a manner of rotating about the hinge 16.

According to an embodiment, a rotation bar 316 may be provided on one of the pair of first doors 31. The rotation bar 316 may be disposed, e.g., on a side opposite to a side of one of the pair of first doors 31 forming a rotation shaft. The rotation bar 316 may be provided such that, e.g., a rotation shaft is fixed to a side surface of one of the pair of first doors 31 to be rotatable about the rotation shaft. The rotation bar 316 may be provided to be positioned in the middle of the front surface of the main body 10 when one of the pair of first doors 31 is in a closed state. The rotation bar 316 may seal a gap between the pair of first doors 31 when the pair of first doors 31 are closed. The main body 10 may be provided with a rotation bar guide 15 for guiding the movement of the rotation bar 316 when one of the pair of first doors 31 is closed.

According to an embodiment, the door 30 (e.g., the first door 31 or the second door 32) may include a door panel 30a or a door body 30b. The door panel 30a and the door body 30b may be detachably coupled to each other.

According to an embodiment, for example, one side of the door body 30b may be fixed to the main body 10 by the hinge 16. The door body 30b may be provided to be rotatable about the main body 10. The door panel 30a may form, e.g., a portion of the front exterior of the refrigerator 1. The door panel 30a may play an important role for aesthetics, especially when the refrigerator 1 is disposed indoors. Accordingly, the user may decorate the front exterior of the refrigerator 1 as desired by replacing it with a door panel 30a having a different color or design. According to an embodiment, the door panel 30a and the door body 30b may be integrally formed with each other.

Hereinafter, for convenience of description, only one first door 31 and one second door 32 are described, and a description of the remaining first door 31 and the remaining second door 32 is omitted. However, the first door 31 and the second door 32, which are not described, may be substantially the same as the first door 31 and the second door 32, which are described below, except that they are provided to be symmetrical to each other. Further, the same configuration as that of the first door 31 may be applied to the second door 32, and a detailed description thereof may be omitted.

According to an embodiment, the first door 31 may include a first door handle (not shown), a first door shelf 313, a first shelf support 314, or a first gasket 315. The first door 31 may be rotatably coupled to the main body 10 to open and close at least a portion of the first storage compartment 21. The user may open and close the first door 31 using the first door handle. The first door handle may be recessed in the bottom surface of the first door 31 or may protrude from the front surface of the first door 31, but the disclosure is not limited thereto.

According to an embodiment, the first door shelf 313 may be provided to receive, e.g., food. First shelf supports 314 may be provided on both left and right sides of the first door shelf 313 to support the first door shelf 313. The first shelf support 314 may extend vertically from, e.g., the first door 31. In other words, the first shelf support 314 may be provided to protrude backward from the rear surface of the first door 31 and extend in the up-down direction. For example, the first shelf support 314 may be detachably provided on the first door 31 as a separate component, or may be integrally formed with the first door 31. The first shelf support 314 may be formed to protrude rearward from, e.g., the rear surface of the door body 30b.

According to an embodiment, the first gasket 315 may be provided to surround, e.g., a rear edge of the first door 31. Specifically, the first gasket 315 may be provided to surround an edge of the door body 30b. The first gasket 315 may be provided to seal a gap with the main body 10 in a state in which the first door 31 is closed.

According to an embodiment, the second door 32 may include a second door handle 321 or a second gasket 322. The second door 32 may be rotatably coupled to the main body 10 to open and close the second storage compartment 22 or the third storage compartment 23. The user may open and close the second door 32 using the second door handle 321. The second door handle 321 may be recessed in the upper surface of the second door 32 or may protrude from the front surface of the second door 32, but the disclosure is not limited thereto.

According to an embodiment, the second gasket 322 may be provided to surround, e.g., a rear edge of the second door 32. The second gasket 322 may be provided to seal a gap with the main body 10 in a state in which the second door 32 is closed.

Although not illustrated, the second door 31 may further include all or some of the same components as the first door shelf 313 and the first shelf support 314 of the first door 32.

According to an embodiment, the refrigerator 1 may include a top table 13 provided on an upper portion of the main body 10. The top table 13 may be coupled to an upper portion of the outer housing 12. For example, the top table 13 may be coupled to the upper surface of the outer housing 12. For example, the top table 13 may be fixed to the outer housing 12.

According to an embodiment, the top table 13 may cover various electronic components. A receiving space in which various electronic components are received may be formed inside the top table 13. For example, the top table 13 may cover the door driving module 400 to be described below, and the door driving module 400 may be received inside the top table 13. Accordingly, the top table 13 may be referred to as a door driving module cover. A more detailed description of the structure of the top table 13 is given below.

Although the refrigerator 1 according to an embodiment of the disclosure has been described as an example of the disclosure assuming that the refrigerator 1 is an indirect cooling-type refrigerator, the spirit of the disclosure is not limited thereto and may also be applied to a direct cooling-type refrigerator.

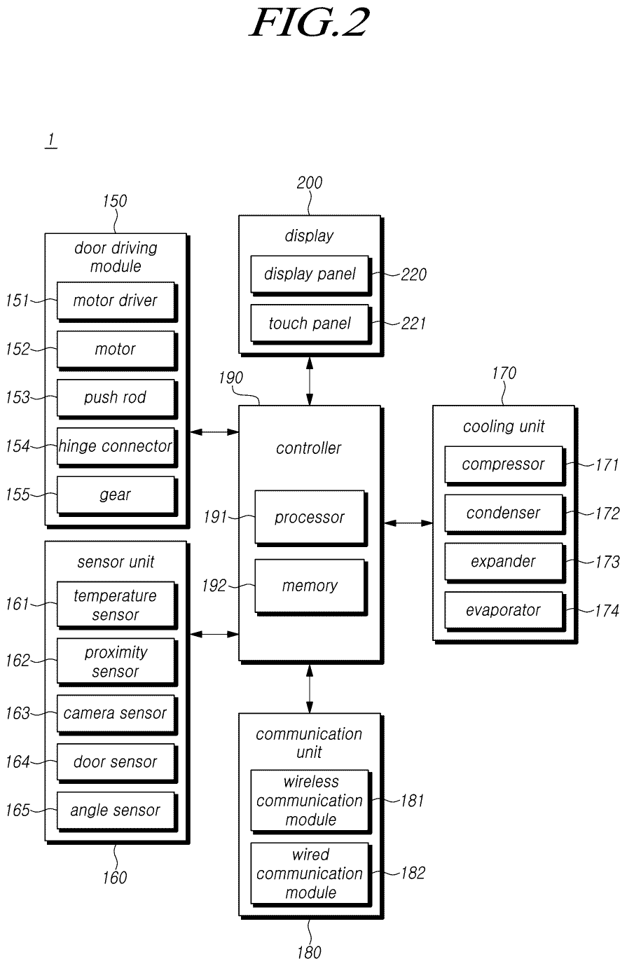

FIG. 2 is a block diagram illustrating a configuration of a refrigerator according to an embodiment of the disclosure.

According to an embodiment, the refrigerator 1 may include a door driving module 150, a sensor unit 160, a cooling unit 170, a communication unit 180, a controller 190, and/or a display 200.

According to an embodiment, the door driving module 150 may control opening or closing of at least one door. The door driving module 150 may include at least one of a motor driver 151, a motor 152, a push rod 153, a hinge connector 154, and a gear 155. For example, the door driving module 150 may precisely control the movement of at least one door 30 according to whether at least one door 30 is opened or the degree of opening.

According to an embodiment, the motor driver 151 may control the motor. For example, the motor driver 151 may activate or deactivate the motor 152. For example, the motor driver 151 may control the operation state of the motor 152 by supplying or cutting off power to the motor 152.

According to an embodiment, the motor 152 may open at least one door by rotating. For example, the motor 152 may be activated based on the control of the motor driver, thereby opening at least one door. For example, the motor 152 may be deactivated based on the control of the motor driver, thereby closing at least one door.

According to an embodiment, the push rod 153 may push the door 30 to open the door 30 from the main body 10 or the storage compartment 20. For example, the push rod 153 may receive the power transferred from the motor 152 through the gear 155 to slide in the front direction from the main body 10 or the storage compartment 20.

According to an embodiment, the hinge connector 154 may push the door 30 to open the door 30 from the main body 10 or the storage compartment 20. One side of the hinge connector 154 may be connected to the main body 10, and the other side may be rotatably connected to the door 30. For example, the hinge connector 154 may receive the power transferred from the motor 152 through the gear 155 to open the door 30 while sliding in the front direction from the main body 10 or the storage compartment 20.

According to an embodiment, the gear 155 may transfer the power transferred from the motor 152 to the push rod 153 and/or the hinge connector 154. For example, the gear 155 is a plurality of power transfer members and may include a pinion gear for transferring power to the push rod 153. For example, the gear 155 is a plurality of power transfer members and may include a clutch unit and connection gears for transferring power to the hinge connector 154.

According to an embodiment, the sensor unit 160 may include a temperature sensor 161, a proximity sensor 162, a camera sensor 163, and a door opening/closing sensor 164.

According to an embodiment, the temperature sensor 161 may sense the temperature around the refrigerator 1 or inside the refrigerator 1. For example, the temperature sensor 161 may include a plurality of temperature sensors for sensing the temperature inside the storage compartment 20. For example, the temperature sensor 161 may include a plurality of temperature sensors for sensing the external temperature around the refrigerator 1.

For example, the plurality of temperature sensors may be installed in the plurality of storage compartments 20, respectively, to sense the temperature of each of the plurality of storage compartments 20 and output an electrical signal corresponding to the sensed temperature to the controller 190. Each of the plurality of temperature sensors may include a thermistor whose electrical resistance changes according to temperature.

According to an embodiment, the proximity sensor 162 may be a sensor that detects whether a distance to a person or an object is close within a predetermined distance by detecting a change in distance from a person or an object. For example, the proximity sensor 162 may identify the user's approach and detect the distance between the user and the refrigerator 1.

For example, the proximity sensor 162 may include at least one of an infrared sensor, an ultrasonic sensor, a capacitive sensor, and an inductive sensor.

According to an embodiment, the camera sensor 163 may be a sensor that generates a digital image by converting light collected in a sensing area into an electrical signal. For example, the camera sensor 163 may photograph objects around the refrigerator 1 or inside the refrigerator 1 and generate a digital image.

For example, the camera sensor 163 may include at least one of a complementary metal-oxide-semiconductor (CMOS) sensor, a charge-coupled device (CCD) sensor, an IR camera, and an RGB camera.

According to an embodiment, the distance detection sensor 164 may detect the distance between the door 30 and the external object (e.g., the user) and transfer a value determined according to a designated distance to the processor 191.

According to an embodiment, the angle sensor 165 may detect the angle between the refrigerator main body 10 and the door 30 and transfer a value determined according to a designated angle value to the processor 191. The angle sensor 165 may detect the position of the door 30 by various methods. For example, the angle sensor 165 may be provided to detect the magnetic field of a magnet mounted adjacent to the door driving module 150 (e.g., the gear 155). The angle sensor 165 may detect a change in magnetic field by the magnet according to the movement of the door 30. For example, the angle sensor 165 may include a hall sensor detecting the magnetic field. However, the type of the angle sensor 165 is not limited thereto, and may include various types of sensors capable of detecting the angle of the door 30 from the main body 10. For example, the position detection sensor 450 may include various types of sensors such as a reed switch or an optical sensor.

According to an embodiment, the cooling unit 170 may supply cooled air to the storage compartment. Specifically, the cooling unit 170 may maintain the temperature of the storage compartment within a range designated by the user using the circulation of the refrigerant in the refrigerant circuit.

According to an embodiment, the cooling unit 170 may include a compressor 171 for compressing the gaseous refrigerant, a condenser 172 for converting the compressed gaseous refrigerant into a liquid state, an expander 173 for decompressing the liquid refrigerant, and an evaporator 174 for converting the decompressed liquid refrigerant into a gaseous state. The cooling unit 170 may cool the air in the storage compartment using the phenomenon in which the liquid refrigerant absorbs thermal energy of the surrounding air while converting to the gaseous state.

However, the cooling unit 170 is not limited as including a refrigerant circuit. For example, the cooling unit 170 may include a Peltier element using the Peltier effect or a magnetic cooling material using a magnetic thermal effect.

According to an embodiment, the communication unit 180 may exchange data with external devices such as the server device and/or the user device and/or the display 200 and/or the cooking device.

According to an embodiment, the communication unit 180 may include a wired communication module 182 for wiredly exchanging data with external devices and a wireless communication module 181 for wirelessly exchanging data with external devices.

According to an embodiment, the wired communication module 182 may access a wired communication network and communicate with external devices through the wired communication network. For example, the wired communication module 182 may access the wired communication network through Ethernet (Ethernet, IEEE 802.3 technology standard) and receive data from the external devices through the wired communication network.

According to an embodiment, the wireless communication module 181 may wirelessly communicate with a base station or an access point (AP), and may access the wired communication network through the base station or the access point. The wireless communication module 181 may also communicate with the external devices connected to the wired communication network via the base station or the access point. For example, the wireless communication module 181 may wirelessly communicate with the access point (AP) using Wi-Fi (IEEE 802.11 technology standard), or communicate with the base station using CDMA, WCDMA, GSM, long term evolution (LET), or Wi-Bro. The wireless communication module 181 may also receive data from the external devices via the base station or the access point. Further, the wireless communication module 181 may directly communicate with the external devices. For example, the wireless communication module 181 may receive data wirelessly from the external devices using Wi-Fi, Bluetooth (IEEE 802.15.1 technology standard), ZigBee (IEEE 802.15.4 technology standard), etc.

According to an embodiment, the communication unit 180 may transmit or receive data with the external devices, and in particular, may receive video data including video and/or audio from the external devices and output the received data to the controller 190.

According to an embodiment, the controller 190 may process user input and/or door opening/closing detection data and/or communication data, and control the components included in the refrigerator 1 based on data processing.

According to an embodiment, the controller 190 includes a memory 192 that stores/records programs and/or data, and a processor 191 that processes user input and/or door opening/closing detection data and/or communication data according to the program and/or data stored in the memory 192.

According to an embodiment, the memory 192 may store/memory a program and/or data. The program includes a plurality of instructions combined to perform a specific function, and the data may be processed and/or treated by a plurality of instructions included in the program. Further, the program and/or data may include system programs and/or system data directly related to the operation of the refrigerator 1, and application programs and/or application data that provide convenience to the user.

According to an embodiment, the memory 192 may include a non-volatile memory storing a program and/or data for controlling the components included in the refrigerator 1 and a volatile memory storing temporary data generated during controlling the components included in the refrigerator 1.

According to an embodiment, the non-volatile memory may store programs and/or data, e.g., electrically, magnetically or optically. The non-volatile memory may include, e.g., a read only memory or flash memory for storing data for a long time. The non-volatile memory may also include a solid state drive (SSD), a hard disk drive (HDD), or an optical disc drive (ODD).

According to an embodiment, the volatile memory may load the program and/or data from the non-volatile memory, e.g., and may electrically store the program and/or data. The volatile memory may include, e.g., static random access memory (S-RAM) and dynamic random access memory (D-RAM) for temporarily storing data.

The memory 192 may store/record programs and data such as operating systems (OS), middleware, and applications, and may provide the programs and data to the processor 191 in response to a request of the processor 191.

According to an embodiment, the processor 191 may process a user input of the display 200 and detection data of the sensor unit 160, driving data of the door driving module 150, and/or communication data of the communication unit 180 according to the program and/or data stored/recorded in the memory 192. The processor 191 may generate a control signal for controlling the sensor operation of the sensor unit 160, the driving of the door driving module 150, and the operation of the communication unit 180 based on data processing.

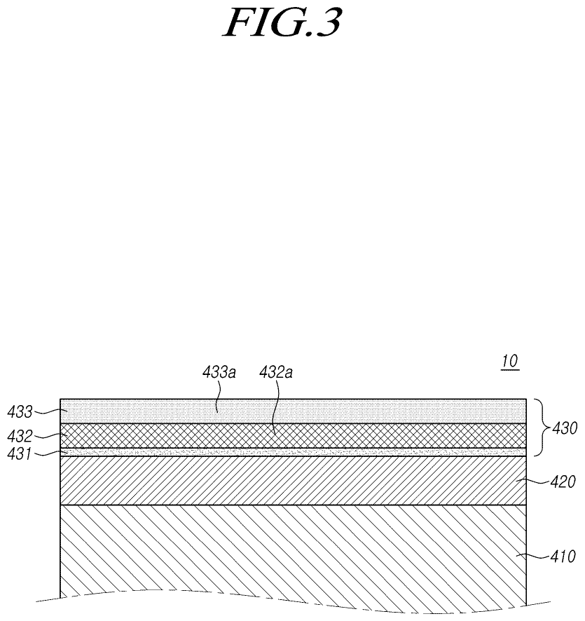

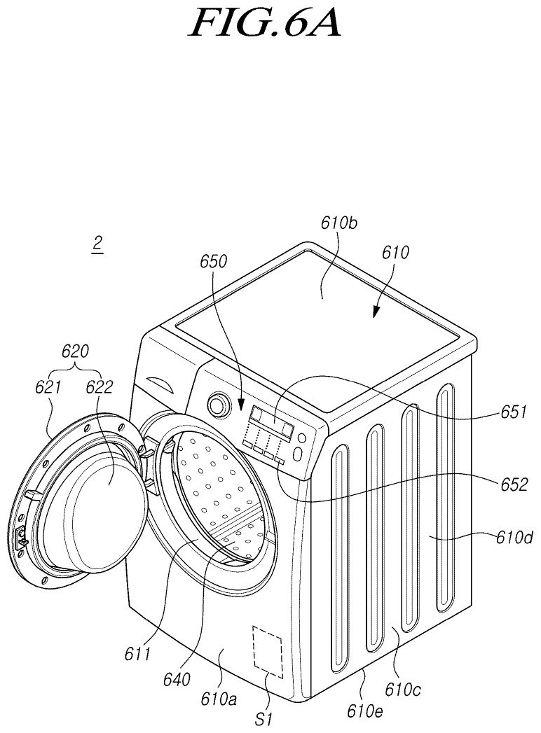

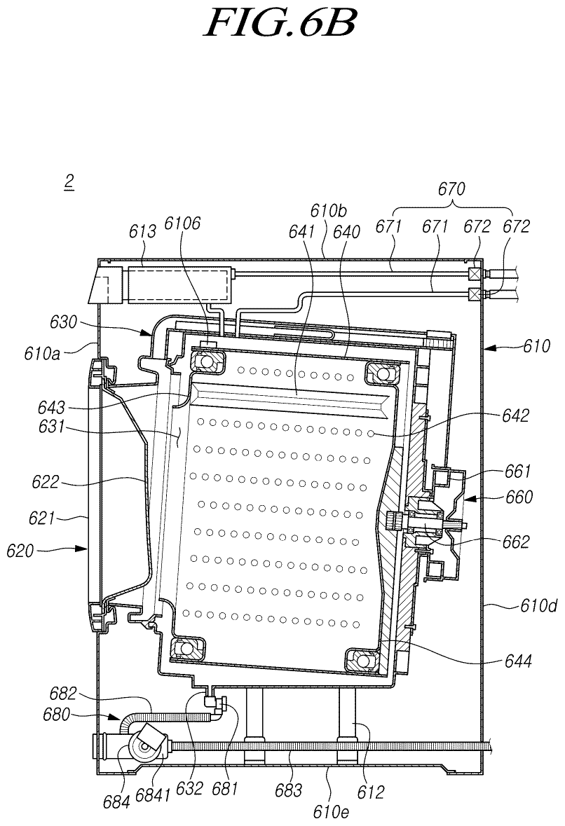

FIG. 3 is a cross-sectional view of a portion of a main body forming the exterior of a home appliance according to an embodiment of the disclosure. For example, FIG. 3 is an enlarged view of a cross section of an area S of the main body 10 of the refrigerator 1 of FIG. 1. For example, FIG. 3 is an enlarged view of a cross section of an area S1 of the main body 610 of the washing machine 2 of FIG. 6A.

Referring to FIG. 3, the configuration of the main body 10 of the home appliance may be identical in whole or part to the configuration of the main body 10 of the refrigerator 1 of FIGS. 1 and 2. Referring to FIG. 3, the configuration of the main body 10 of the home appliance may be identical in whole or part to the configuration of the main body 610 of the washing machine 2 of FIGS. 6A and 6B.

The embodiment of FIG. 3 may be selectively combined with the embodiments of FIGS. 1, 2, and 5 to 6B.

Referring to FIG. 3, the main body 10 (e.g., exterior material) forming the exterior of the refrigerator 1 may be press-molded using an iron plate material or injection-molded using a resin material.

According to an embodiment, the main body 10 may include a frame 410 and a coating layer 430 (e.g., a coating composition) disposed (e.g., coated or deposited) on the frame 410.

According to an embodiment, the main body 10 may include a frame 410, a plating layer 420 disposed on the frame 410, and a coating layer 430 (e.g., a coating composition) disposed (e.g., coated or deposited) on the plating layer 420.

According to an embodiment, the coating layer 430 may have a structure in which a plurality of resin layers are stacked. The coating layer 430 may include a primer layer (or primer resin) 431, a base layer (or base resin) 432, and a clear layer (or clear resin) 433.

According to an embodiment, the refrigerator (e.g., the refrigerator 1 of FIG. 1) includes a main body 10 and a door (e.g., the door 30 of FIG. 1), and the coating layer 430 may form a portion of an outer surface of at least one of the outer housing (e.g., the outer housing 12 of FIG. 1) of the main body 10 or the door 30. For example, the outer housing 12 may include an upper cover, a left/right cover, or a lower cover, and the coating layer 430 may form a portion of an outer surface of the left/right cover (e.g., a front pre-coated metal (PCM)) that may directly give an aesthetic feel to the user among the covers. However, rather than forming the exterior while being limited to the left/right cover, the coating layer 430 may be variously disposed (e.g., coated and deposited) on the exterior easily seen from the outside, such as the door 30, the upper cover, or the lower cover.

According to an embodiment, the frame 410 may be formed to protect the main body 10 of the refrigerator 1 and to have high durability. The frame 410 may support the overall shape of the refrigerator 1. The frame 410 may include at least one of metal or plastic. For example, the frame 410 may be formed of a stainless steel (SUS) material.

According to an embodiment, a plating layer 420 may be disposed on the frame 410. For example, the plating layer 420 formed by chemical treatment on the outer surface of the frame 410 may enhance the corrosion resistance of the main body 10 and the durability of the frame 410, including steel.

According to an embodiment, the plating layer 420 (or the chemically treated layer) may be a zinc plating layer. For example, the zinc coating layer, which is obtained by performing a zinc coating process on the surface of the frame 410 including steel, may block direct contact of the steel of the frame 410 to oxygen or moisture or limit (e.g., prevent or reduce) corrosion. The zinc plating layer may increase adhesion to the resin layer, thereby enhancing adhesion to the resin layer disposed on the zinc plating layer.

According to an embodiment, the plating layer 420 may be formed through at least one of electro-galvanizing, hot-dip galvanizing, spray zinc spraying, or zinc-aluminum coating on the frame 410.

According to an embodiment, the coating layer 430 may be disposed on the frame 410 or the plating layer 420. For example, the coating layer 430 may be provided directly on the frame 410, or after the plating layer 420 is provided on the frame 410, the coating layer 430 may be provided on the plating layer 420.

According to an embodiment, the coating layer 430 may have a structure in which a plurality of resin layers are stacked, and may be formed by a multi-coating process. For example, after one resin layer is applied, drying and curing processes may be carried out, and the above process may be repeated a designated number of times to form a structure in which the plurality of resin layers are stacked.

According to an embodiment, the coating layer 430 may include a primer layer 431, a base layer 432, and a clear layer 433. The primer layer 431, the base layer 432, and the clear layer 433 may form a stacked structure.

According to an embodiment, after the primer layer 431 is applied on the frame 410 or the plating layer 420, drying and curing processes may be performed. Thereafter, after the base layer 432 is applied on the primer layer 431, drying and curing processes may be performed. Thereafter, after the clear layer 433 is applied on the base layer 432, drying and curing processes may be performed. Accordingly, different functional characteristics of each resin layer may be provided to the main body 10 (e.g., exterior material) through the coating layer 430 using the plurality of resin layers.

According to an embodiment, the coating layer 430 may be designed to form the base layer 432 and/or the clear layer 433 as a layer with low molecular properties to enhance luminance and/or contrast (to have high brightness and/or high contrast) and, to enhance adhesion and processability which are decreased thereby, form the primer layer 431 with a composite material.

According to an embodiment, the primer layer 431, the base layer 432, and the clear layer 433 form their respective layers, and may be stacked on the frame 410 or the plating layer 420 in the order of the primer layer 431, the base layer 432, and the clear layer 433. The primer layer 431, the base layer 432, and the clear layer 433 each may include a petroleum resin such as polyethylene or polymethyl methacrylate (PMMA) and/or a bio-based resin such as biomass, as a main component, and may further include other various components such as resins, additives, or pigments.

According to an embodiment, the primer layer 431 is formed on the base material to enhance adhesion to the base layer 432, and may serve to help the base layer 432 adhere better by enhancing the properties of the surface. The primer layer 431 may also promote chemical bonding with the base layer 432 to enhance the durability and performance of the resin.

According to an embodiment, the base layer 432 may be disposed on the primer layer 431 and may include a first bio-based resin 432a based on a biomass. According to an embodiment, the base layer 432 may be formed based on a combination of a plurality of resins or a single resin. For example, the resin of the base layer 432 may be a combination of the first petroleum-based resin (not shown) and the first bio-based resin 432a. For example, the resin of the base layer 432 may be formed of a first bio-based resin 432a.

According to an embodiment, the content of the first bio-based resin 432a of the base layer 432 may be 10 wt % to 100 wt % relative to the total resin weight. For example, in the base layer 432, the content of the first bio-based resin 432a may be about 10 wt % relative to the total resin weight, and the content of the first petroleum-based resin may be about 90 wt % relative to the total resin weight. For example, in the base layer 432, the content of the first bio-based resin 432a may be about 30 wt % relative to the total resin weight, and the content of the first petroleum-based resin may be about 70 wt % relative to the total resin weight. For example, in the base layer 432, the content of the first bio-based resin 432a may be about 60 wt % relative to the total resin weight, and the content of the first petroleum-based resin may be about 40 wt % relative to the total resin weight. For example, in the base layer 432, the content of the first bio-based resin 432a may be about 100 wt % relative to the total resin weight.

According to an embodiment, when the content of the first bio-based resin 432a of the base layer 432 is 10 to 99 wt % relative to the total resin weight, the first bio-based resin 432a and the first petroleum-based resin may have different average molecular weights MW, transition temperatures Tg, and OH values.

According to an embodiment, the first petroleum-based resin uses a petroleum-based monomer and may include a material derived from petroleum. For example, the first petroleum-based resin may include polyethylene, which may be synthesized from an ethylene monomer. Ethylene may be produced mainly from natural gas extracted from petroleum. Further, the first petroleum-based resin may include polypropylene, which may be synthesized from a propylene monomer. Propylene may be produced in petrochemical processes. Further, the first petroleum-based resin may include various petroleum-based resins such as polystyrene, polyvinyl chloride (PVC), and polyurethane. However, the petroleum-based monomer used in the first petroleum-based resin is not limited to the above examples, and may include various raw materials extractable in a petrochemical process.

According to an embodiment, the first bio-based resin 432a is based on a biomass-based monomer, and a material derived from a biological raw material may be used. For example, the first bio-based resin 432a may include various biomass monomers such as acrylic biomass monomers, ester biomass monomers, amide biomass monomers, alcohol biomass monomers, lignin-based biomass monomers, sugar-based biomass monomers, and catechol-based biomass monomers. The acrylic biomass monomer may include bio-acrylate, and may be synthesized based on vegetable oil or glucose. The ester biomass monomer may include biodimethyl terephthalate (bio-DMT), and may be produced from raw materials extracted from crops. The amide biomass monomer may include bio-caprolactam and may be synthesized from vegetable raw materials. The alcohol biomass monomer may include bio-propylene glycol, and may be produced by fermenting glycerol. The lignin-based biomass monomer may include lignin, and lignin may be produced as a raw material extracted from wood. The sugar-based biomass monomer may include glucose and may be extracted from vegetable resources (e.g., corn, sugarcane, wheat, and potatoes). The catechol biomass monomer includes catechol and may be extracted from vegetable resources (e.g., corn, sugarcane, wheat, and potatoes). However, the biomass monomer for the first bio-based resin 432a is not limited to the above examples, and may include various raw materials that may be extracted from renewable resources such as plants and microorganisms.

Table 1 below shows the average molecular weight MW, transition temperature Tg, and OH value of the first petroleum-based resin and the first bio-based resin 432a of the base layer 432.

TABLE 1

| | Layer | Base (PE base resin) | |
|---|---|---|---|
| Paint | Items | Bio-based resin | Petroleum-based resin |
| Resin | Resin molecular | 2,500 | 5,500 |
| | weight(Mw) | | |
| | Tg(° C.) | 10 | 15 |
| | OH Value | 20 | 22 |

According to an embodiment, when the content of the first bio-based resin 432a of the base layer 432 is 10 wt % to 99 wt % relative to the total resin weight, the first bio-based resin 432a and the first petroleum-based resin may have different average molecular weights MW, transition temperatures Tg, and OH values.

Referring to Table 1, the average molecular weight MW of the first bio-based resin 432a may be smaller than the average molecular weight MW of the first petroleum-based resin. For example, the first bio-based resin 432a may have an average molecular weight MW of about 2,000 to 5,000 g/mol. For example, the first bio-based resin 432a may have an average molecular weight MW of about 2,000 to 3,000 g/mol. For example, the first bio-based resin 432a may have an average molecular weight MW of about 2,500 g/mol. For example, the average molecular weight MW of the first petroleum-based resin may be about 5,000 to 10,000 g/mol. For example, the average molecular weight MW of the first petroleum-based resin may be about 5,000 to 6,000 g/mol. For example, the average molecular weight MW of the first petroleum-based resin may be about 5,500 g/mol.

Referring to Table 1, the transition temperature Tg of the first bio-based resin 432a may be smaller than the transition temperature Tg of the first petroleum-based resin. For example, the transition temperature of the first bio-based resin 432a may be about 10° C., and the transition temperature of the first petroleum-based resin may be about 15° C. As the transition temperature is relatively high, the resin may have high cross-linking density, chemical resistance, and adhesion, and as the transition temperature is relatively low, the coating film may be softened to enhance processability.

Referring to Table 1, the OH value of the first bio-based resin 432a may be smaller than the OH value of the first petroleum-based resin. For example, the OH value of the first bio-based resin 432a may be about 20, and the OH value of the first petroleum-based resin may be about 22. OH value is an important chemical indicator for evaluating the content and reactivity of hydroxyl groups and may play a key role in the manufacture of polymer compounds. The paint of the disclosure may design and adjust the physical properties of the product through the OH value.

According to an embodiment, when the content of the first bio-based resin 432a of the base layer 432 is 100 wt % relative to the total resin weight, the first bio-based resin 432a may have an average molecular weight MW, a transition temperature Tg, and an OH value as disclosed in Table 1.

According to an embodiment, the clear layer 433 may be disposed on the base layer 432 and may include a second bio-based resin 433a based on biomass. According to an embodiment, the clear layer 433 may be formed based on a combination of a plurality of resins or a single resin. For example, the resin of the clear layer 433 may be a combination of a second petroleum-based resin (not shown) and a second bio-based resin 433a. For example, the resin of the clear layer 433 may be formed of a second bio-based resin 433a.

According to an embodiment, the content of the second bio-based resin 433a of the clear layer 433 may be 10 wt % to 100 wt % relative to the total resin weight. For example, in the clear layer 433, the content of the second bio-based resin 433a may be about 10 wt % relative to the total resin weight, and the content of the second petroleum-based resin may be about 90 wt % relative to the total resin weight. For example, in the clear layer 433, the content of the second bio-based resin 433a may be about 30 wt % relative to the total resin weight, and the content of the second petroleum-based resin may be about 70 wt % relative to the total resin weight. For example, in the clear layer 433, the content of the second bio-based resin 433a may be about 60 wt % relative to the total resin weight, and the content of the second petroleum-based resin may be about 40 wt % relative to the total resin weight. For example, the clear layer 433 may include about 100 wt % of the second bio-based resin 433a relative to the total resin weight.

According to an embodiment, when the content of the second bio-based resin 433a of the clear layer 433 is 10 to 99 wt % relative to the total resin weight, the second bio-based resin 433a and the second petroleum-based resin may have different average molecular weights MW, transition temperatures Tg, and OH values.

According to an embodiment, the second petroleum-based resin uses a petroleum-based monomer and may include a material derived from petroleum. For example, the second petroleum resin may include poly(methyl methacrylate) (PMMA), which may be synthesized through a polymerization reaction from a methyl methacrylate (MMA) monomer. Methyl methacrylate may be produced mainly from compounds derived from petroleum. For example, the second petroleum-based resin may include polyethylene, which may be synthesized from an ethylene monomer. Ethylene may be produced mainly from natural gas extracted from petroleum. Further, the second petroleum-based resin may include polypropylene, which may be synthesized from a propylene monomer. Propylene may be produced in petrochemical processes. Further, the second petroleum-based resin may include various petroleum-based resins such as polystyrene, polyvinyl chloride (PVC), and polyurethane. However, the petroleum-based monomer used in the second petroleum-based resin is not limited to the above examples, and may include various raw materials extractable in a petrochemical process.

According to an embodiment, the second bio-based resin 433a is based on a biomass-based monomer, and a material derived from a biological raw material may be used. For example, the second bio-based resin 433a may include various biomass monomers such as acrylic biomass monomers, ester biomass monomers, amide biomass monomers, alcohol biomass monomers, lignin-based biomass monomers, sugar-based biomass monomers, and catechol-based biomass monomers. The acrylic biomass monomer may include bio-acrylate, and may be synthesized based on vegetable oil or glucose. The ester biomass monomer may include biodimethyl terephthalate (bio-DMT), and may be produced from raw materials extracted from crops. The amide biomass monomer may include bio-caprolactam and may be synthesized from vegetable raw materials. The alcohol biomass monomer may include bio-propylene glycol, and may be produced by fermenting glycerol. The lignin-based biomass monomer may include lignin, and lignin may be produced as a raw material extracted from wood. The sugar-based biomass monomer may include glucose and may be extracted from vegetable resources (e.g., corn, sugarcane, wheat, and potatoes). The catechol biomass monomer includes catechol and may be extracted from vegetable resources (e.g., corn, sugarcane, wheat, and potatoes). However, the biomass monomer for the second bio-based resin 433a is not limited to the above examples, and may include various raw materials that may be extracted from renewable resources such as plants and microorganisms.

Table 2 below shows the average molecular weight MW, transition temperature Tg, and OH value of the second bio-based resin 433a and the second petroleum-based resin of the clear layer 433.

TABLE 2

| | Layer | CLEAR (PE + Acrylic resin) | |
|---|---|---|---|
| Paint | Items | Bio-based resin | Petroleum-based resin |
| Resin | Resin molecular | 15,000 | 2,300 |
| | weight(Mw) | | |
| | Tg(° C.) | 14 | 18 |
| | OH Value | 30 | 71 |

According to an embodiment, when the content of the second bio-based resin 433a of the clear layer 433 is 10 wt % to 99 wt % relative to the total resin weight, the second bio-based resin 433a and the second petroleum-based resin may have different average molecular weights MW, transition temperatures Tg, and OH values.

Referring to Table 2, the average molecular weight MW of the second bio-based resin 433a may be larger than the average molecular weight MW of the second petroleum-based resin. For example, the second bio-based resin 433a may have an average molecular weight MW of about 10,000 to 20,000 g/mol. For example, the second bio-based resin 433a may have an average molecular weight MW of about 13,000 to 17,000 g/mol. For example, the second bio-based resin 433a may have an average molecular weight MW of about 15,000 g/mol. For example, the average molecular weight MW of the second petroleum-based resin may be about 1,000 to 3,000 g/mol. The average molecular weight MW of the second petroleum-based resin may be about 2,000 to 2,600 g/mol. For example, the average molecular weight MW of the second petroleum-based resin may be about 2,300 g/mol. For example, the average molecular weight MW of the second petroleum-based resin may be about 10,000 to 25,000 g/mol.

Referring to Table 2, the transition temperature Tg of the second bio-based resin 433a may be smaller than the transition temperature Tg of the second petroleum-based resin. For example, the transition temperature of the second bio-based resin 433a may be about 14° C., and the transition temperature of the second petroleum-based resin may be about 18° C. As the transition temperature is relatively high, the resin may have high cross-linking density, chemical resistance, and adhesion, and as the transition temperature is relatively low, the coating film may be softened to enhance processability.

Referring to Table 2, the OH value of the second bio-based resin 433a may be smaller than the OH value of the second petroleum-based resin. For example, the OH value of the second bio-based resin 433a may be about 30, and the OH value of the second petroleum-based resin may be about 71. OH value is an important chemical indicator for evaluating the content and reactivity of hydroxyl groups and may play a key role in the manufacture of polymer compounds. The paint of the disclosure may design and adjust the physical properties of the product through the OH value.

According to an embodiment, when the content of the second bio-based resin 433a of the clear layer 433 is 100 wt % relative to the total resin weight, the second bio-based resin 433a may have an average molecular weight MW, a transition temperature Tg, and an OH value as disclosed in Table 2.

According to an embodiment, each of the base layer 432 and the clear layer 433 may include a bio-based resin, such as biomass, as the main resin, along with additional resins, pigments, additives, and/or auxiliary materials, such as thinners.

Table 3 below shows the composition in the bio-based resin (e.g., the first bio-based resin 432a and the second bio-based resin 433a) along with the resin content in the paint (e.g., the base layer 432 and the clear layer 433).

TABLE 3

| | | Items | | | | | | | | | |
|---|---|---|---|---|---|---|---|---|---|---|---|
| | | Case 1_bio 10% | | Case 2_bio 20% | | Case 3_bio 30% | | Case 4_bio 60% | | Case 5_bio 100% | |
| | | Base | Clear | Base | Clear | Base | Clear | Base | Clear | Base | Clear |
| Compo- | Resin | 65~70 wt % | | | | | | | | | |
| sition | content(wt %) | | | | | | | | | | |
| | Solvent(wt %) | 15~20 | 15~20 | 15~20 | 15~20 | 15~20 | 15~20 | 15~20 | 15~20 | 15~20 | 15~20 |
| | (Bio content in | 5~10 | 10~15 | 20~25 | 25~30 | 30~35 | 35~40 | 55~60 | 60~65 | 100 | 100 |
| | resin wt %) | | | | | | | | | | |
| | (Petroleum-based | 50~55 | 45~50 | 35~40 | 30~35 | 25~30 | 20~25 | 10~15 | 5~10 | | |
| | content in resin | | | | | | | | | | |
| | wt %) | | | | | | | | | | |
| | Curing agent(wt %) | 5~10 | 5~10 | 5~10 | 5~10 | 5~10 | 5~10 | 10~15 | 10~15 | 10~15 | 10~15 |
| | Inorganic | 0.2~0.4 | 0.2~0.4 | 0.2~0.4 | 0.2~0.4 | 0.2~0.4 | 0.2~0.4 | 0.3~0.5 | 0.3~0.5 | 0.4~0.6 | 0.4~0.6 |
| | additives(wt %) | | | | | | | | | | |
| | Silica(wt %) | 0.1~0.2 | 0.1~0.2 | 0.1~0.2 | 0.1~0.2 | 0.1~0.2 | 0.1~0.2 | 0.2~0.3 | 0.2~0.3 | 0.3~0.4 | 0.3~0.4 |
| | Zirconium(wt %) | 0.1~0.2- | 0.1~0.2- | 0.1~0.2- | 0.1~0.2- | 0.1~0.2- | 0.1~0.2- | 0.1~0.2 | 0.1~0.2 | 0.1~0.2 | 0.1~0.2 |
| | Defoamer(wt %) | 0.2~0.5 | 0.2~0.5 | 0.2~0.5 | 0.2~0.5 | 0.2~0.5 | 0.2~0.5 | 0.3~0.5 | 0.3~0.5 | 0.3~0.5 | 0.3~0.5 |
| | Catalyst(wt %) | 0.5~1.0 | 0.5~1.0 | 0.5~1.0 | 0.5~1.0 | 0.5~1.0 | 0.5~1.0 | 1.0~1.5 | 1.0~1.5 | 1.5~2.0 | 1.5~2.0 |

According to an embodiment, the base layer 432 and/or the clear layer 433 may include a resin and a solvent, and the resin may include a bio-based resin, a petroleum-based resin, and other impurities (e.g., additives). The content of the resin (e.g., the bio-based resin and the petroleum-based resin) in the base layer 432 and/or the clear layer 433 may be about 60 wt % to 75 wt %. The content of the resin in the base layer 432 and/or the clear layer 433 may be about 65 wt % to 70 wt %.

Referring to Table 3, the composition of the resin may be identified using experimental data in which the content of the first bio-based resin 432a is about 5 wt % to 10 wt % relative to the total resin weight in the base layer 432, and experimental data in which the content of the second bio-based resin 433a is about 10 wt % to 15 wt % relative to the total resin weight in the clear layer 433, as “Case 1_bio 10%”.

According to an embodiment, the first bio-based resin 432a of the base layer 432 and the second bio-based resin 433a of the clear layer 433 in Case 1 may each include biomass. According to an embodiment, the resin of the base layer 432 and the resin of the clear layer 433 in Case 1 each may include a bio-based resin and inorganic additives. According to an embodiment, the resin of the base layer 432 and the resin of the clear layer 433 in Case 1 may each include a bio-based resin, a petroleum-based resin, an inorganic additive, a curing agent, a defoamer, a catalyst, and other additives.

According to an embodiment, the inorganic additives in the resin of the base layer 432 in Case 1 may include a ceramic-based material. According to an embodiment, in Case 1, the inorganic additives in the resin of the base layer 432 may include silica (Si) and zirconium (Zr). In the process step, the inorganic additive is added in powder form, and the silica may be understood as silicon (hereinafter, referred to as silica (Si)), and the zirconium may also be understood as zirconia (hereinafter, referred to as zirconium (Zr)).

In general, when the content of the bio-based resin is increased, the content of the petroleum-based resin may be decreased, and chemical resistance and mechanical properties may be degraded. The base layer 432 of the disclosure may form a structurally stable coating film by combining inorganic additives such as silica (Si) and zirconium (Zr) with a linear structure of a bio-based resin (e.g., biomass). Accordingly, the base layer 432 may enhance chemical resistance and mechanical properties by adjusting the content of the inorganic additive in the resin. The inorganic additive may be prepared using silica (Si) and zirconium (Zr) alone or by adjusting a ratio of silica (Si) and zirconium (Zr) as shown in Table 3.

According to an embodiment, the content of the inorganic additive in the resin of the base layer 432 may be about 0.2 wt % to 0.6 wt % relative to the total resin weight. According to an embodiment, the content of the inorganic additive in the resin of the base layer 432 may be about 0.2 wt % to 0.4 wt % relative to the total resin weight. The silica content of the inorganic additive may be about 0.1 wt % to 0.2 wt % relative to the total inorganic additive weight, and the zirconium content may be about 0.1 wt % to 0.2 wt % relative to the total inorganic additive weight.

According to an embodiment, the content of the curing agent in the resin of the base layer 432 may be 5.0 wt % to 10.0 wt % relative to the total resin weight. The content of the defoamer in the resin of the base layer 432 may be about 0.2 wt % to 0.5 wt % relative to the total resin weight, and the content of the catalyst may be about 0.5 wt % to 1.0 wt % relative to the total resin weight.

According to an embodiment, inorganic additives in the resin of the clear layer 433 in Case 1 may include ceramic-based materials. According to an embodiment, in Case 1, the inorganic additives in the resin of the clear layer 433 may include silica (Si) and zirconium (Zr). In general, when the content of the bio-based resin is increased, the content of the petroleum-based resin may be decreased, and chemical resistance and mechanical properties may be degraded. The base layer 432 of the disclosure may form a structurally stable coating film by combining inorganic additives such as silica (Si) and zirconium (Zr) with a linear structure of a bio-based resin (e.g., biomass). Accordingly, the clear layer 433 may enhance chemical resistance and mechanical properties by adjusting the content of the inorganic additive in the resin. The inorganic additive may be prepared using silica (Si) and zirconium (Zr) alone or by adjusting a ratio of silica (Si) and zirconium (Zr) as shown in Table 3.

According to an embodiment, the content of the inorganic additive in the resin of the clear layer 433 may be about 0.2 wt % to 0.6 wt % relative to the total resin weight. According to an embodiment, the content of the inorganic additive in the resin of the clear layer 433 may be about 0.2 wt % to 0.4 wt % relative to the total resin weight. The silica content of the inorganic additive may be about 0.1 wt % to 0.2 wt % relative to the total inorganic additive weight, and the zirconium content may be about 0.1 wt % to 0.2 wt % relative to the total inorganic additive weight.

According to an embodiment, the content of the curing agent in the resin of the clear layer 433 may be 5.0 wt % to 10.0 wt % relative to the total resin weight. The content of the defoamer in the resin of the clear layer 433 may be about 0.2 wt % to 0.5 wt % relative to the total resin weight, and the content of the catalyst may be about 0.5 wt % to 1.0 wt % relative to the total resin weight.

Referring to Table 3, the composition of the resin may be identified using experimental data in which the content of the first bio-based resin 432a is about 20 wt % to 25 wt % relative to the total resin weight in the base layer 432, and experimental data in which the content of the second bio-based resin 433a is about 25 wt % to 30 wt % relative to the total resin weight in the clear layer 433, as “Case 2_bio 20%”.

According to an embodiment, the first bio-based resin 432a of the base layer 432 and the second bio-based resin 433a of the clear layer 433 in Case 2 may each include biomass. According to an embodiment, the resin of the base layer 432 and the resin of the clear layer 433 in Case 2 each may include a bio-based resin and inorganic additives. According to an embodiment, the resin of the base layer 432 and the resin of the clear layer 433 in Case 2 may each include a bio-based resin, a petroleum-based resin, an inorganic additive, a curing agent, a defoamer, a catalyst, and other additives.

According to an embodiment, the inorganic additives in the resin of the base layer 432 in Case 2 may include a ceramic-based material. According to an embodiment, in Case 2, the inorganic additives in the resin of the base layer 432 may include silica (Si) and zirconium (Zr). In general, when the content of the bio-based resin is increased, the content of the petroleum-based resin may be decreased, and chemical resistance and mechanical properties may be degraded. The base layer 432 of the disclosure may form a structurally stable coating film by combining inorganic additives such as silica (Si) and zirconium (Zr) with a linear structure of a bio-based resin (e.g., biomass). Accordingly, the base layer 432 may enhance chemical resistance and mechanical properties by adjusting the content of the inorganic additive in the resin. The inorganic additive may be prepared using silica (Si) and zirconium (Zr) alone or by adjusting a ratio of silica (Si) and zirconium (Zr) as shown in Table 3.

According to an embodiment, the content of the inorganic additive in the resin of the base layer 432 may be about 0.2 wt % to 0.6 wt % relative to the total resin weight. According to an embodiment, the content of the inorganic additive in the resin of the base layer 432 may be about 0.2 wt % to 0.4 wt % relative to the total resin weight. The silica content of the inorganic additive may be about 0.1 wt % to 0.2 wt % relative to the total inorganic additive weight, and the zirconium content may be about 0.1 wt % to 0.2 wt % relative to the total inorganic additive weight.

According to an embodiment, the content of the curing agent in the resin of the base layer 432 may be 5.0 wt % to 10.0 wt % relative to the total resin weight. The content of the defoamer in the resin of the base layer 432 may be about 0.2 wt % to 0.5 wt % relative to the total resin weight, and the content of the catalyst may be about 0.5 wt % to 1.0 wt % relative to the total resin weight.

According to an embodiment, inorganic additives in the resin of the clear layer 433 in Case 2 may include ceramic-based materials. According to an embodiment, in Case 2, the inorganic additives in the resin of the clear layer 433 may include silica (Si) and zirconium (Zr). In general, when the content of the bio-based resin is increased, the content of the petroleum-based resin may be decreased, and chemical resistance and mechanical properties may be degraded. The base layer 432 of the disclosure may form a structurally stable coating film by combining inorganic additives such as silica (Si) and zirconium (Zr) with a linear structure of a bio-based resin (e.g., biomass). Accordingly, the clear layer 433 may enhance chemical resistance and mechanical properties by adjusting the content of the inorganic additive in the resin. The inorganic additive may be prepared using silica (Si) and zirconium (Zr) alone or by adjusting a ratio of silica (Si) and zirconium (Zr) as shown in Table 3.

According to an embodiment, the content of the inorganic additive in the resin of the clear layer 433 may be about 0.2 wt % to 0.6 wt % relative to the total resin weight. According to an embodiment, the content of the inorganic additive in the resin of the clear layer 433 may be about 0.2 wt % to 0.4 wt % relative to the total resin weight. The silica content of the inorganic additive may be about 0.1 wt % to 0.2 wt % relative to the total inorganic additive weight, and the zirconium content may be about 0.1 wt % to 0.2 wt % relative to the total inorganic additive weight.

According to an embodiment, the content of the curing agent in the resin of the clear layer 433 may be 5.0 wt % to 10.0 wt % relative to the total resin weight. The content of the defoamer in the resin of the clear layer 433 may be about 0.2 wt % to 0.5 wt % relative to the total resin weight, and the content of the catalyst may be about 0.5 wt % to 1.0 wt % relative to the total resin weight.

Referring to Table 3, the composition of the resin may be identified using experimental data in which the content of the first bio-based resin 432a is about 30 wt % to 35 wt % relative to the total resin weight in the base layer 432, and experimental data in which the content of the second bio-based resin 433a is about 35 wt % to 40 wt % relative to the total resin weight in the clear layer 433, as “Case 3_bio 30%”.

According to an embodiment, the first bio-based resin 432a of the base layer 432 and the second bio-based resin 433a of the clear layer 433 in Case 3 may each include biomass. According to an embodiment, the resin of the base layer 432 and the resin of the clear layer 433 in Case 3 each may include a bio-based resin and inorganic additives. According to an embodiment, the resin of the base layer 432 and the resin of the clear layer 433 in Case 3 may each include a bio-based resin, a petroleum-based resin, an inorganic additive, a curing agent, a defoamer, a catalyst, and other additives.

According to an embodiment, the inorganic additives in the resin of the base layer 432 in Case 3 may include a ceramic-based material. According to an embodiment, in Case 2, the inorganic additives in the resin of the base layer 432 may include silica (Si) and zirconium (Zr). The base layer 432 may enhance chemical resistance and mechanical properties by adjusting the content of the inorganic additive in the resin. The inorganic additive may be prepared using silica (Si) and zirconium (Zr) alone or by adjusting the ratio as shown in Table 3.

According to an embodiment, the content of the inorganic additive in the resin of the base layer 432 may be about 0.2 wt % to 0.6 wt % relative to the total resin weight. According to an embodiment, the content of the inorganic additive in the resin of the base layer 432 may be about 0.2 wt % to 0.4 wt % relative to the total resin weight. The silica content of the inorganic additive may be about 0.1 wt % to 0.2 wt % relative to the total inorganic additive weight, and the zirconium content may be about 0.1 wt % to 0.2 wt % relative to the total inorganic additive weight.

According to an embodiment, the content of the curing agent in the resin of the base layer 432 may be 5.0 wt % to 10.0 wt % relative to the total resin weight. The content of the defoamer in the resin of the base layer 432 may be about 0.2 wt % to 0.5 wt % relative to the total resin weight, and the content of the catalyst may be about 0.5 wt % to 1.0 wt % relative to the total resin weight.

According to an embodiment, inorganic additives in the resin of the clear layer 433 in Case 3 may include ceramic-based materials. According to an embodiment, in Case 2, the inorganic additives in the resin of the clear layer 433 may include silica (Si) and zirconium (Zr). The clear layer 433 may enhance chemical resistance and mechanical properties by adjusting the content of the inorganic additive in the resin. The inorganic additive may be prepared using silica (Si) and zirconium (Zr) alone or by adjusting the ratio as shown in Table 3.

According to an embodiment, the content of the inorganic additive in the resin of the clear layer 433 may be about 0.2 wt % to 0.6 wt % relative to the total resin weight. According to an embodiment, the content of the inorganic additive in the resin of the base layer 432 may be about 0.2 wt % to 0.4 wt % relative to the total resin weight. The silica content of the inorganic additive may be about 0.1 wt % to 0.2 wt % relative to the total inorganic additive weight, and the zirconium content may be about 0.1 wt % to 0.2 wt % relative to the total inorganic additive weight.

According to an embodiment, the content of the curing agent in the resin of the clear layer 433 may be 5.0 wt % to 10.0 wt % relative to the total resin weight. The content of the defoamer in the resin of the clear layer 433 may be about 0.2 wt % to 0.5 wt % relative to the total resin weight, and the content of the catalyst may be about 0.5 wt % to 1.0 wt % relative to the total resin weight.

Referring to Table 3, the composition of the resin may be identified using experimental data in which the content of the first bio-based resin 432a is about 55 wt % to 60 wt % relative to the total resin weight in the base layer 432, and experimental data in which the content of the second bio-based resin 433a is about 60 wt % to 65 wt % relative to the total resin weight in the clear layer 433, as “Case 4_bio 60%”.

According to an embodiment, the first bio-based resin 432a of the base layer 432 and the second bio-based resin 433a of the clear layer 433 in Case 4 may each include biomass. According to an embodiment, the resin of the base layer 432 and the resin of the clear layer 433 in Case 4 each may include a bio-based resin and inorganic additives. According to an embodiment, the resin of the base layer 432 and the resin of the clear layer 433 in Case 4 may each include a bio-based resin, a petroleum-based resin, an inorganic additive, a curing agent, a defoamer, a catalyst, and other additives.

According to an embodiment, the inorganic additives in the resin of the base layer 432 in Case 4 may include a ceramic-based material. According to an embodiment, in Case 4, the inorganic additives in the resin of the base layer 432 may include silica (Si) and zirconium (Zr). The base layer 432 may enhance chemical resistance and mechanical properties by adjusting the content of the inorganic additive in the resin. The inorganic additive may be prepared using silica (Si) and zirconium (Zr) alone or by adjusting the ratio as shown in Table 3.

According to an embodiment, the content of the inorganic additive in the resin of the base layer 432 may be about 0.2 wt % to 0.6 wt % relative to the total resin weight. According to an embodiment, the content of the inorganic additive in the resin of the base layer 432 may be about 0.3 wt % to 0.5 wt % relative to the total resin weight. The silica content of the inorganic additive may be about 0.2 wt % to 0.3 wt % relative to the total inorganic additive weight, and the zirconium content may be about 0.1 wt % to 0.2 wt % relative to the total inorganic additive weight.

According to an embodiment, the content of the curing agent in the resin of the base layer 432 may be 10.0 wt % to 15.0 wt % relative to the total resin weight. The content of the defoamer in the resin of the base layer 432 may be about 0.3 wt % to 0.5 wt % relative to the total resin weight, and the content of the catalyst may be about 1.0 wt % to 1.5 wt % relative to the total resin weight.

According to an embodiment, inorganic additives in the resin of the clear layer 433 in Case 4 may include ceramic-based materials. According to an embodiment, in Case 4, the inorganic additives in the resin of the clear layer 433 may include silica (Si) and zirconium (Zr). The clear layer 433 may enhance chemical resistance and mechanical properties by adjusting the content of the inorganic additive in the resin. The inorganic additive may be prepared using silica (Si) and zirconium (Zr) alone or by adjusting the ratio as shown in Table 3.

According to an embodiment, the content of the inorganic additive in the resin of the clear layer 433 may be about 0.2 wt % to 0.6 wt % relative to the total resin weight. According to an embodiment, the content of the inorganic additive in the resin of the base layer 432 may be about 0.3 wt % to 0.5 wt % relative to the total resin weight. The silica content of the inorganic additive may be about 0.2 wt % to 0.3 wt % relative to the total inorganic additive weight, and the zirconium content may be about 0.1 wt % to 0.2 wt % relative to the total inorganic additive weight.

According to an embodiment, the content of the curing agent in the resin of the clear layer 433 may be 10.0 wt % to 15.0 wt % relative to the total resin weight. The content of the defoamer in the resin of the clear layer 433 may be about 0.3 wt % to 0.5 wt % relative to the total resin weight, and the content of the catalyst may be about 1.0 wt % to 1.5 wt % relative to the total resin weight.

Referring to Table 3, the composition of the resin may be identified using experimental data in which the content of the first bio-based resin 432a is about 100 wt % relative to the total resin weight in the base layer 432, and experimental data in which the content of the second bio-based resin 433a is about 100 wt % relative to the total resin weight in the clear layer 433, as “Case 5_bio 100%”.

According to an embodiment, the first bio-based resin 432a of the base layer 432 and the second bio-based resin 433a of the clear layer 433 in Case 5 may each include biomass. According to an embodiment, the resin of the base layer 432 and the resin of the clear layer 433 in Case 5 each may include a bio-based resin and inorganic additives. According to an embodiment, the resin of the base layer 432 and the resin of the clear layer 433 in Case 5 may each include a bio-based resin, a petroleum-based resin, an inorganic additive, a curing agent, a defoamer, a catalyst, and other additives.

According to an embodiment, the inorganic additives in the resin of the base layer 432 in Case 5 may include a ceramic-based material. According to an embodiment, in Case 4, the inorganic additives in the resin of the base layer 432 may include silica (Si) and zirconium (Zr). The base layer 432 may enhance chemical resistance and mechanical properties by adjusting the content of the inorganic additive in the resin. The inorganic additive may be prepared using silica (Si) and zirconium (Zr) alone or by adjusting the ratio as shown in Table 3.

According to an embodiment, the content of the inorganic additive in the resin of the base layer 432 may be about 0.2 wt % to 0.6 wt % relative to the total resin weight. According to an embodiment, the content of the inorganic additive in the resin of the base layer 432 may be about 0.4 wt % to 0.6 wt % relative to the total resin weight. The silica content of the inorganic additive may be about 0.3 wt % to 0.4 wt % relative to the total inorganic additive weight, and the zirconium content may be about 0.1 wt % to 0.2 wt % relative to the total inorganic additive weight.

According to an embodiment, the content of the curing agent in the resin of the base layer 432 may be 10.0 wt % to 15.0 wt % relative to the total resin weight. The content of the defoamer in the resin of the base layer 432 may be about 0.3 wt % to 0.5 wt % relative to the total resin weight, and the content of the catalyst may be about 1.5 wt % to 2.0 wt % relative to the total resin weight.

According to an embodiment, inorganic additives in the resin of the clear layer 433 in Case 5 may include ceramic-based materials. According to an embodiment, in Case 5, the inorganic additives in the resin of the clear layer 433 may include silica (Si) and zirconium (Zr). The clear layer 433 may enhance chemical resistance and mechanical properties by adjusting the content of the inorganic additive in the resin. The inorganic additive may be prepared using silica (Si) and zirconium (Zr) alone or by adjusting the ratio as shown in Table 3.

According to an embodiment, the content of the inorganic additive in the resin of the clear layer 433 may be about 0.2 wt % to 0.6 wt % relative to the total resin weight. According to an embodiment, the content of the inorganic additive in the resin of the base layer 432 may be about 0.4 wt % to 0.6 wt % relative to the total resin weight. The silica content of the inorganic additive may be about 0.3 wt % to 0.4 wt % relative to the total inorganic additive weight, and the zirconium content may be about 0.1 wt % to 0.2 wt % relative to the total inorganic additive weight.

According to an embodiment, the content of the curing agent in the resin of the clear layer 433 may be 10.0 wt % to 15.0 wt % relative to the total resin weight. The content of the defoamer in the resin of the clear layer 433 may be about 0.3 wt % to 0.5 wt % relative to the total resin weight, and the content of the catalyst may be about 1.5 wt % to 2.0 wt % relative to the total resin weight.

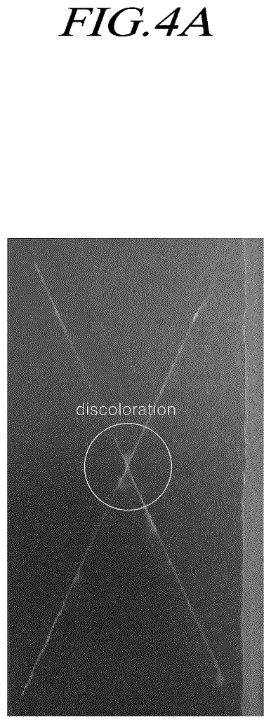

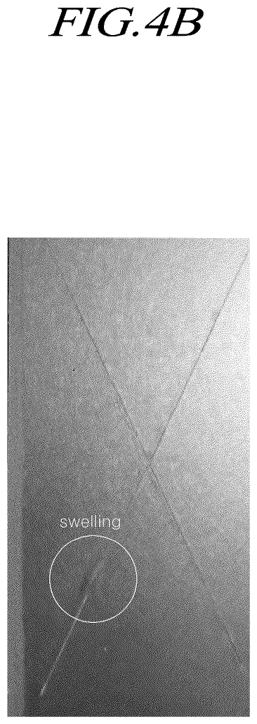

FIGS. 4A and 4B are views illustrating results of a chemical resistance test on a coating layer of a general home appliance (e.g., a refrigerator or a washing machine) under a specific condition.

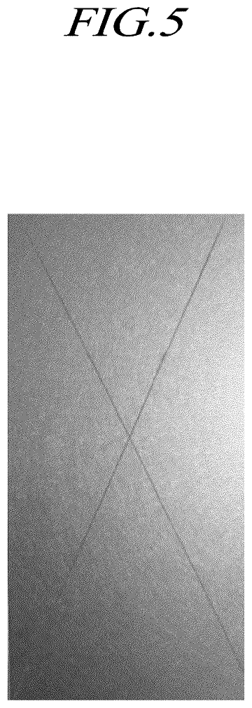

FIG. 5 is a view illustrating results of a chemical resistance test on a coating layer of a home appliance (e.g., a refrigerator or a washing machine) under a specific condition according to an embodiment of the disclosure.

Referring to FIG. 5, the configuration of the main body 10 of the home appliance may be identical in whole or part to the configuration of the main body 10 of the refrigerator 1 of FIGS. 1 and 2. Referring to FIG. 5, the configuration of the main body 10 of the home appliance may be identical in whole or part to the configuration of the main body 610 of the washing machine 2 of FIGS. 6A and 6B.

The embodiment of FIG. 5 may be selectively combined with the embodiments of FIGS. 1, 2, 3, 6A, and 6B.

According to an embodiment, the main body 10 of the home appliance may include a frame (e.g., the frame 410 of FIG. 3), a plating layer (e.g., the plating layer 420) disposed on the frame 410, and a coating layer (e.g., the coating layer 430 of FIG. 3) disposed (e.g., coated or deposited) on the plating layer 420.

According to an embodiment, the coating layer 430 may have a structure in which a plurality of resin layers are stacked. The coating layer 430 may include a primer layer (or primer resin) 431, a base layer (or base resin) 432, and a clear layer (or clear resin) 433.

According to an embodiment, the base layer (e.g., the base layer 432 of FIG. 3) may include a first bio-based resin (e.g., the first bio-based resin 432a of FIG. 3) based on biomass and inorganic additives. The content of the inorganic additive in the clear layer may be 0.2 wt % to 0.6 wt % relative to the total resin weight.

According to an embodiment, the clear layer (e.g., the clear layer 433 of FIG. 3) may include a second bio-based resin (e.g., the second bio-based resin 433a of FIG. 3) based on biomass and inorganic additives. The content of the inorganic additive in the clear layer may be 0.2 wt % to 0.6 wt % relative to the total resin weight.

According to an embodiment, the base layer 432 and the clear layer 433 including the bio-based resin and inorganic additives may have enhanced chemical resistance and mechanical properties compared to the base layer and the clear layer including only general bio-based resin.

Table 4 below shows the evaluation of the physical property experiments of the base layer and the clear layer containing only general bio-based resin.

Table 5 below shows the evaluation of physical property experiments of the base layer 432 and the clear layer 433 including a bio-based resin and inorganic additives in the resin according to an embodiment. The composition of Table 3 above may be applied to the composition related to the bio-based resin and inorganic additives of Table 5.

TABLE 4

| | | Items | | | | | |
|---|---|---|---|---|---|---|---|
| | | Control_Petroleum- | | | | | |
| | | based resin | | Case #1_bio 10% | | Case #2_bio 15% | |
| | | Base | Clear | Base | Clear | Base | Clear |
| Bio | Bio content | 0 | 0 | 10~15 | 10~15 | 15~20 | 15~20 |
| content in | Petroleum- | 60~70 | 60~70 | 45~50 | 45~50 | 35~40 | 35~40 |
| resin | based | | | | | | |
| | content | | | | | | |

| | | | | |
|---|---|---|---|---|
| Physical | Processability | 2T OK | 1T OK | 1T OK |
| properties | Hardness | F | HB | HB |
| | Corrosion | OK | NG | NG |
| | resistance | | | |
| | Alkali | OK | NG | NG |
| | resistance | | | |

TABLE 5

| | | Items | | | | | | | | | |
|---|---|---|---|---|---|---|---|---|---|---|---|
| | | Case 1_bio 10% | | Case 2_bio 15% | | Case 3_bio 30% | | Case 4_bio 60% | | Case 5_bio 100% | |
| | | Base | Clear | Base | Clear | Base | Clear | Base | Clear | Base | Clear |
| Bio | Bio content | 5~10 | 10~15 | 20~25 | 25~30 | 30~35 | 35~40 | 55~60 | 60~65 | 100 | 100 |
| content in | Petroleum- | 50~55 | 45~50 | 35~40 | 30~35 | 25~30 | 20~25 | 10~15 | 5~10 | | |
| resin | based content | | | | | | | | | | |

| | | | | | | |
|---|---|---|---|---|---|---|
| Physical | Processability | 1T OK | 1T OK | 1T OK | 1T OK | 2T OK |
| properties | Hardness | F | F | F | F | F |
| | Corrosion | OK | OK | OK | OK | OK |
| | resistance | | | | | |
| | Alkali | OK | OK | OK | OK | OK |
| | resistance | | | | | |

Referring to Table 4, in each of the base layer and the coating layer of the coating layer, physical properties may be identified using the experimental data in which there is no content of the bio-based resin relative to the total resin weight as “Control_petroleum-based resin”, the experimental data in which the content of the bio-based resin is about 10 wt % to about 15 wt % relative to the total resin weight as “Case #1_bio 10%”, and the experimental data in which the content of the bio-based resin is about 15 wt % to about 20 wt % as “Case #2_bio 15%”.

Referring to Table 5, in each of the base layer (and coating layer) of the coating layer, physical properties may be identified using the experimental data in which the content of the bio-based resin is about 5 wt % to 10 wt % (and 10 wt % to 15 wt %) relative to the total resin weight as “Case 1_bio 10%”, the experimental data in which the content of the bio-based resin is about 20 wt % to about 25 wt % (and 25 wt % to 30 wt %) relative to the total resin weight as “Case 2_bio 20%”, the experimental data in which the content of the bio-based resin is about 30 wt % to 35 wt % (and 35 wt % to 40 wt %) relative to the total resin weight as “Case 3_bio 30%”, the experimental data in which the content of the bio-based resin is about 55 wt % to 60 wt % (and 60 wt % to 65 wt %) relative to the total resin weight as “Case 4_bio 60%”, and the experimental data in which the content of the bio-based resin is about 100 wt % (and 100 wt %) relative to the total resin weight as “Case 5 bio 100%”.

Referring to Table 4, it may be identified that in the processability experiments, the Control_petroleum-based resin, Case #1_bio 10%, and Case #2_bio 15% are all determined as appropriate (OK), but Case #1_bio 10% and Case #2_bio 15% are determined as inappropriate (NG) in the hardness, corrosion resistance, and alkali resistance experiments.

In comparison, referring to Table 5, it may be identified that Case 1_bio 10%, Case 2_bio 20%, Case 3_bio 30%, Case 4_bio 60%, and Case 5_bio 100% (the base layer 432 and the clear layer 433, including inorganic additives) according to an embodiment of the disclosure are all determined as appropriate (OK) in processability, hardness, corrosion resistance, and alkali resistance experiments.

Referring to Table 4 and Table 5, the hardness test is performed by measuring the surface hardness of each of the base layer and the clear layer, and may be identified by a pencil hardness tester. The results measured with the pencil hardness tester may be identified as (about) 3B, 2B, B, HB, F, H, 2H, and 3H (strong), and if F or more, the base layer and the clear layer of the coating layer may be understood as determined as appropriate (OK).

Referring to Table 4, as the results of measurement with the pencil hardness tester, it may be identified that the Control_petroleum-based resin is F grade, Case #1_bio 10% and Case #2_bio 15% are HB grade, which is lower in hardness than Control_petroleum-based resin, and is determined as inappropriate (NG).

Referring to Table 5, it may be identified that Case 1_bio 10%, Case 2_bio 20%, Case 3_bio 30%, Case 4_bio 60%, and Case 5_bio 100 (the base layer 432 and the clear layer 433 including inorganic additives) are F grade and determined as appropriate (OK). Through the experiments, it may be identified that the coating layer 430 including the inorganic additives together with the bio-based resin enhances the unstable hardness of the coating layer containing only the general bio-based resin, thereby providing mechanical properties (e.g., hardness) suitable for the exterior material.

The corrosion resistance experiments were conducted on the respective Lab samples of Control_petrochemical resin, Case #1_bio 10%, and Case #2_bio 15% of Table 4 above through a brine spray test. The corrosion resistance experiments were conducted on the respective samples of Case 1_bio 10%, Case 2_bio 20%, Case 3_bio 30%, Case 4_bio 60%, and Case 5_bio 100 (the base layer 432 and the clear layer 433 including inorganic additives) in Table 5 above through a brine spray test.

The brine spray test was performed by performing a total of five to 10 cycles, each cycle including spraying a 5% HCl (or NaCl) solution on the Lab samples for about 8 hours and then resting 10 hours or more (e.g., 16 hours) and then identifying the results. Each of the Lab samples was mounted at 450 so that the brine did not accumulate, and an X-cut was made in the surface of the Lab sample, and the experimental results were identified.

As a result of the corrosion resistance experiment, the respective samples of Case #1_bio 10% and Case #2_bio 15% were swollen within the fifth day. In contrast, as a result of the corrosion resistance experiment, it was identified that no swelling occurred in the respective samples of Case 1_bio 10%, Case 2_bio 20%, Case 3_bio 30%, Case 4_bio 60%, and Case 5_bio 100% (the base layer 432 and the coating layer 433 including inorganic additives). Through the experiments, it may be identified that the coating layer 430 including the inorganic additives together with the bio-based resin enhances the unstable corrosion resistance of the coating layer containing only the general bio-based resin, thereby providing chemical resistance (e.g., corrosion resistance) suitable for the exterior material.

The alkali resistance experiment was conducted by immersing the respective Lab samples of Control_petrochemical resin, Case #1_bio 10%, and Case #2_bio 15% of Table 4 in a designated solution. The corrosion resistance experiments were conducted by immersing the respective Lab samples of Case 1_bio 10%, Case 2_bio 20%, Case 3_bio 30%, Case 4_bio 60%, and Case 5_bio 100 (the base layer 432 and the clear layer 433 including inorganic additives) in a designated solution.

In the alkali resistance test method, cuts were made to the respective coated portions of the Lab samples, and then immersed (e.g., half immersed) in a 5% NaOH solution for a designated time (e.g., about 24 hours to about 48 hours) and, if swelling or discoloration or air bubbles occur, it may be identified as having inappropriate adhesion capability.

As a result of the alkali resistance experiment, the respective samples of Case #1_bio 10% and Case #2_bio 15% were discolored and swollen (e.g., see FIGS. 4A and 4B). In contrast, as a result of corrosion resistance experiments, it was identified that no swelling, discoloration, or air bubbles occurred (e.g., increased chemical resistance) (e.g., see FIG. 5) in the respective samples of Case 1_bio 10%, Case 2_bio 20%, Case 3_bio 30%, Case 4_bio 60%, and Case 5_bio 100%. Through the experiments, it may be identified that the coating layer 430 including inorganic additives together with the bio-based resin enhances unstable chemical resistance of the coating layer containing only general bio-based resins, thereby providing chemical resistance (e.g., alkali resistance) suitable for exterior materials.

The coating layer (e.g., the base layer 432, and the clear layer 433) according to an embodiment is used for an exterior material of the refrigerator 1 or an exterior material of the washing machine 2, and hereinafter, a configuration of the washing machine 2 is described. However, the coating layer (e.g., the base layer 432 and the clear layer 433) is not limited to the exterior materials for the refrigerator 1 and the washing machine 2, and may be easily design-changed and applied to various home appliances using eco-friendly exterior materials such as robot vacuums, cooking devices, or air purifiers.

FIG. 6A is a perspective view illustrating an outer appearance of a washing machine according to an embodiment of the disclosure.

FIG. 6B is a side cross-sectional view illustrating a washing machine according to an embodiment of the disclosure.

FIGS. 6A and 6B are views overall illustrating a washing machine 2 which is a home appliance. FIGS. 6A and 6B are exemplary views for convenience of description, and the scope of the disclosure is not limited thereto.

According to an embodiment, the washing machine 2 may include a main body 610 for receiving various components therein. The main body 610 may have an overall hexahedral shape. The main body 610 may include an opening formed in the front surface (or front cover 610a). Two or more of the surfaces of the main body 610 may be integrally formed. Each surface of the main body 610 may be separately manufactured and assembled. The main body 610 may be, e.g., press-molded with an iron plate material or injection-molded with a resin material.

According to an embodiment, the main body 610 may include a front cover 610a, an upper cover 610b, a left/right side cover 610c, a rear cover 610d, or a lower cover 610e. The components included in the main body 610 may be configured individually or integrally. For example, the left/right side cover 610c and the rear cover 610d included in the main body 610 may be integrally formed to form a side and rear cover. The front cover 610a, upper cover 610b, left/right side cover 610c, rear cover 610d, or lower cover 610e included in the main body 610 may provide an internal housing. The inner housing may include an inner space in which various components constituting the washing machine 2 may be stored or mounted.

According to an embodiment, at least a portion of the main body 610 may include a steel plate structure. In the main body 610, at least one of the front cover 610a, the upper cover 610b, the left/right side cover 610c, the rear cover 610d, or the lower cover 610e may be formed of a steel plate structure.

According to an embodiment, a door 620 for opening and closing the corresponding opening may be provided in a portion corresponding to the opening of the main body 610. The door 620 may be rotatably coupled to a hinge fixed to one surface of the main body 610. For example, at least a portion of the door 620 may be provided to be transparent or translucent so as to be visible inside. The user may open and close the door 620 to put the laundry into the drum 640 positioned inside the main body 610 or withdraw the laundry from the drum 640. For example, the door 620 may be locked by a locking device (not shown) so as not to be opened while the washing machine 2 is running. According to an embodiment, the door 620 may include a door frame 621 and a glass member 622. The glass member 622 may be formed of, e.g., a transparent tempered glass material to see through the inside of the main body 610, but the disclosure is not limited thereto.

According to an embodiment, the washing machine 2 may include a tub 630 fixedly disposed inside the main body 610. The tub 630 may have a substantially cylindrical shape with one side open. A tub opening 631 may be provided in the front surface of the tub 630 at a position corresponding to the opening of the main body 610. The tub 630 may store washing water. A drain port 632 for draining washing water may be provided under the tub 630. The drain port 632 may be connected to, e.g., the drain unit 680.

According to an embodiment, the washing machine 2 may include a damper 612. The damper 612 may be provided to connect the main body 610 and the tub 630. One side of the damper 612 may be fixed to the inner surface of the main body 610 and the other side of the damper 12 may be fixed to the tub 630. The damper 612 may be provided to attenuate vibration by absorbing vibration energy transferred to the tub 630 and/or the main body 610 when the drum 640 rotates.

According to an embodiment, the washing machine 2 may include a drum 640 provided inside the tub 630. The drum 640 may have a substantially cylindrical shape with one side open. A front plate 643 and a rear plate 644 may be disposed on the front surface and the rear surface, respectively, of the drum 640. The front plate 643 may be provided with a drum opening at a position corresponding to the opening of the main body 610 and the tub opening 631 of the tub 630. The drum 640 may receive laundry. The drum 640 may receive rotational power from the driver 60 and rotate inside the tub 630. The drum 640 may perform washing, rinsing, and/or spinning while rotating inside the tub 630.

According to an embodiment, the drum 640 may include a lifter 641 and/or a plurality of through holes 642. The lifter 641 may lift the laundry while the drum 640 rotates so that the laundry repeatedly rises and falls, thereby evenly washing laundry on several surfaces thereof. The through hole 642 may be a passage formed so that the water or washing water accommodated in the tub 630 flows into the drum 640 or the water or washing water inside the drum 640 is discharged to the outside. In an example, the lifter 641 or the through hole 642 may be omitted.

According to an embodiment, the washing machine 2 may include a control panel 650 that supports interaction between the user and the washing machine 2. The control panel 650 may be disposed at an upper end of the front surface of the main body 610 as illustrated in FIG. 6A, but the disclosure is not limited thereto. In an example, the control panel 650 may include an input unit 651 and a display unit 652.

According to an embodiment, the input unit 651 may include any type of user input means for obtaining a user input for controlling the washing machine 2. The user may input power on/off, washing setting information (e.g., operation start/stop, course selection, time selection, etc.) of the washing machine 2 through the input unit 651. According to an embodiment, the input unit 651 may be a tact switch, a push switch, a slide switch, a toggle switch, a micro switch, or a touch switch, but the disclosure is not limited thereto. For example, the input unit 651 may be in the form of a jog shuttle that the user may grip and rotate. According to an embodiment, the input unit 651 may include an infrared sensor. The user may remotely input the setting information through the remote control, and the input setting information may be received by the input unit 651 as an infrared signal. According to an embodiment, the input unit 651 may include a microphone. Setting information by the user's voice may be obtained through a microphone.

According to an embodiment, the display unit 652 may display various washing setting information and/or operation state information about the washing machine 2 input from the user. The display unit 652 may include various types of display panels such as an LCD, an LED, an OLED, a QLED, and a micro LED. For example, the display unit 652 may be implemented as a touch screen with a touch pad provided on the front surface thereof, but the disclosure is not limited to a specific type of display means. According to an embodiment, the display unit 652 may include any type of audio display means including a speaker, and may display each of the above-described information as an auditory signal through the audio display means. According to an embodiment, the display unit 652 may operate to audibly provide the user with information for guiding the user's input and/or information related to the ongoing process. According to an embodiment, the display unit 652 may provide information about the total amount of water used while washing is performed and/or the amount of water used for each cycle. For example, the display unit 652 may separately provide the amount of water supplied while the washing cycle is performed and the amount of water supplied while the rinsing cycle is performed.

According to an embodiment, the washing machine 2 may include a driver 660 for rotating the drum 640. The driver 660 may include a motor 661 and a driving shaft 662 for transferring the driving force generated by the motor 661 to the drum 640. The motor 661 may include a fixed stator and a rotor that rotates by electromagnetically interacting with the stator to convert an electric force into a mechanical rotational force. The rotational force generated by the motor 661 may be transferred to the drum 640 through the driving shaft 662. The driving shaft 662 may be press-fitted into the rotor of the motor 661 to rotate together with the rotor. The driving shaft 662 may partially penetrate the rear wall of the tub 630 to connect the drum 640 and the motor 661. The driver 60 may rotate the drum 640 forward or backward to perform washing, rinsing, and/or spinning cycles.

According to an embodiment, the washing machine 2 may include a water supply unit 670 for supplying washing water to the drum 640 and/or the tub 630. The water supply unit 670 may include at least one water supply pipe 671 and at least one water supply valve 672. The at least one water supply pipe 671 may be provided to supply washing water into the tub 630 using an external water supply source. One of the at least one water supply pipe 671 may be connected to a detergent supply device 613 provided in the main body 610. Here, the detergent supply device 613 may be divided into a plurality of spaces, and each space may be provided with a detergent, a rinsing agent, or the like. The washing water passing through the detergent supply device 613 may be supplied to the tub 630 together with the detergent (or rinsing agent) through the detergent supply pipe. Another one of the at least one water supply pipe 671 may be directly connected to the tub 630. For example, the washing water supplied through the water supply pipe 671 directly connected to the tub 630 may be directly supplied to the tub 630 without going through an intermediate component such as the detergent supply device.

According to an embodiment, the washing machine 2 may include a drain unit 680 for draining the washing water received in the drum 640 and/or the tub 630. The drain unit 680 may include a drain valve 681, a first drain pipe 682, a second drain pipe 683, or a pump chamber 684. The drain unit 680 may be disposed, e.g., under the tub 630 to discharge the washing water discharged from the tub 630 to the outside of the washing machine 2.

According to an embodiment, the drain valve 681 may be provided to open and close the drain port 632. When the drain valve 681 is opened, the washing water received in the tub 630 may flow through the drain port 632 to the drain unit 680.

According to an embodiment, the first drain pipe 682 and the second drain pipe 683 may form a flow path that guides washing water to be discharged to the outside. For convenience of description, the upper stream of the pump chamber 684 is referred to as the first drain pipe 682 and the lower stream is referred to as the second drain pipe 683. The first drain pipe 682 and the second drain pipe 683 may be integrally formed. The first drain pipe 682 may have, e.g., one end connected to the drain port 632 and the other end connected to the pump chamber 684. The washing water may move into the pump chamber 684 along the first drain pipe 682. The second drain pipe 683 may have, e.g., one end connected to the pump chamber 684 and the other end connected to the outside of the washing machine 2. Accordingly, the washing water passing through the pump chamber 684 may be discharged to the outside of the washing machine 2 along the second drain pipe 683.

According to an embodiment, the pump chamber 684 may be provided under the tub 630 to store water or washing water drained from the tub 630. Inside the pump chamber 684, e.g., a drain pump 6841 for discharging the stored water or washing water to the outside may be provided. The water or washing water pumped by the drain pump 6841 may be guided to the outside of the main body 610 through the second drain pipe 683.

According to an embodiment, the washing machine 2 may include a vibration sensor 6106. The vibration sensor 6106 may be disposed on an outer circumferential surface of the drum 640 to sense vibration of the drum 640. According to an embodiment, the vibration sensor 6106 may be disposed in a front direction and/or rear direction of the drum 640. Here, the front direction of the drum 640 may refer to a direction toward the front plate 643, and the rear direction of the drum 640 may refer to a direction toward the rear plate 644. The vibration sensor 6106 may detect vibration while the drum 640 rotates, and the controller (not shown) may calculate the eccentricity value of the drum 640 based on the vibration value measured by the vibration sensor 6106.

According to an embodiment, the washing machine 2 may measure the eccentricity value in the front direction of the drum 640 and the eccentricity value in the rear direction of the drum 640, respectively, using one vibration sensor 6106. For example, the vibration sensor 6106 may be an inertial measurement unit (IMU) sensor (or an inertial measurement device). The IMU sensor may be configured to measure the acceleration corresponding to linear motion and the angular velocity corresponding to rotational motion for each of the x-axis, y-axis, and z-axis.

In general, the main body (e.g., exterior material) of an electronic device (e.g., home appliance) may include a frame and a coating layer in which a plurality of resin layers are stacked, disposed on the frame. The coating layer may include a petroleum-based resin. If the coating layer contains more than a certain level of bio-based resin, it may be difficult to apply it as a paint due to poor chemical resistance and/or mechanical properties.

In the home appliance according to an embodiment of the disclosure, the coating layer of the main body (e.g., the exterior material) may be provided in a structure in which a primer layer, a base layer, and a clear layer are stacked. The base layer and/or the clear layer may provide a paint that meets eco-friendly and chemical resistance factors as it includes an enhanced bio-based resin based on biomass.

In the home appliance according to an embodiment of the disclosure, the coating layer of the main body (e.g., the exterior material) may be provided in a structure in which a primer layer, a base layer, and a clear layer are stacked. The base layer and/or the clear layer may be configured to include a bio-based resin and inorganic additives to provide a coating layer having chemical resistance and mechanical properties corresponding to the petroleum-based resin.

In the home appliance according to an embodiment of the disclosure, the coating layer of the main body (e.g., the exterior material) may be provided in a structure in which a primer layer, a base layer, and a clear layer are stacked. The inorganic additives included in the base layer and/or the clear layer may include silica and zirconium. The enhanced base layer and/or clear layer may form a structurally stable coating film (e.g., increased chemical resistance and mechanical properties) by combining inorganic additives such as silica (Si) and zirconium (Zr) with a linear structure of a bio-based resin.

In the home appliance according to an embodiment of the disclosure, the coating layer of the main body (e.g., the exterior material) may be provided in a structure in which a primer layer, a base layer, and a clear layer are stacked. The base layer and/or clear layer may provide a coating layer containing more bio-based resins, which has been enhanced based on biomass, than petroleum-based resins, thereby providing a coating layer that may meet eco-friendly needs, allow for mass-producing compared to general paints, and reduce production costs.

Effects obtainable from the disclosure are not limited to the above-mentioned effects, and other effects not mentioned may be apparent to one of ordinary skill in the art from the following description.

A refrigerator 1 according to an embodiment of the disclosure may comprise a main body 10, a door 30 rotatably connected to open or close the main body, and a storage compartment 20 disposed in the main body to store food. An exterior material of the main body may include a frame 410 including a metal material, a primer layer 431 disposed on the frame, a base layer 432 disposed on the primer layer and including a first bio resin based on biomass, and a clear layer 433 disposed on the base layer and including a second bio resin based on biomass. Each of the base layer 432 or the clear layer 432 may be configured to contain an inorganic additive for mixing with the biomass.

According to an embodiment, the inorganic additive may include silica (Si) and zirconium (Zr).

According to an embodiment, a content of the inorganic additive contained in the base layer 432 or the clear layer 433 may be 0.2 wt % to 0.6 wt % relative to a total resin weight.

According to an embodiment, a content of the silica of the inorganic additive may be 0.1 wt % to 0.4 wt % relative to a total resin weight, and a content of the zirconium may be 0.1 wt % to 0.2 wt % relative to a total weight.

According to an embodiment, a content of a first bio-based resin 432a of the base layer may be 10 wt % to 100 wt % relative to a total resin weight.

According to an embodiment, a content of a second bio-based resin 433a of the clear layer may be 10 wt % to 100 wt % relative to a total resin weight.

According to an embodiment, an average molecular weight MW of a first bio-based resin 432a of the base layer may be 2,000 to 5,000 g/mol, and an average molecular weight MW of the second bio-based resin 433a of the clear layer may be 10,000 to 20,000 g/mol.

According to an embodiment, an average molecular weight MW of a first petroleum-based resin of the base layer may be 5,000 to 10,000 g/mol, and an average molecular weight MW of a second petroleum-based resin of the clear layer may be 1,000 to 3,000 g/mol.

According to an embodiment, when a content of each of a first bio-based resin of the base layer or a second bio-based resin of the clear layer is 20 wt % to 30 wt % relative to a total resin weight, a content of the inorganic additive in the base layer may be 2 wt % to 4 wt % relative to the total resin weight, or a content of the inorganic additive in the clear layer may be 0.2 wt % to 0.4 wt % relative to the total resin weight.

According to an embodiment, when a content of each of a first bio-based resin of the base layer or a second bio-based resin of the clear layer is 55 wt % to 65 wt % relative to a total resin weight, a content of the inorganic additive in the base layer may be 0.3 wt % to 0.5 wt % relative to the total resin weight, or a content of the inorganic additive in the clear layer may be 0.3 wt % to 0.5 wt % relative to the total resin weight.

According to an embodiment, when a content of each of a first bio-based resin of the base layer or a second bio-based resin of the clear layer is 100 wt % relative to a total resin weight, a content of the inorganic additive in the base layer may be 0.4 wt % to 0.6 wt % relative to the total resin weight, or a content of the inorganic additive in the clear layer may be 0.4 wt % to 0.6 wt % relative to the total resin weight.

According to an embodiment, a content of a first bio-based resin of the base layer may be 20 wt % to 25 wt % relative to a total resin weight, and a content of a second bio-based resin of the clear layer may be 25 wt % to 30 wt % relative to the total resin weight.

According to an embodiment, a content of a curing agent of each of the base layer or the clear layer may be 5.0 wt % to 10.0 wt % relative to the total resin weight, a content of a defoamer may be about 0.2 wt % to 0.5 wt % relative to the total resin weight, and a content of a catalyst may be about 0.5 wt % to 1.0 wt % relative to the total resin weight.

In a home appliance comprising an exterior material according to an embodiment of the disclosure, the exterior material may include a frame 410 including a metal material, a primer layer 431 disposed on the frame, a base layer 432 disposed on the primer layer and including a first bio resin based on biomass, and a clear layer 433 disposed on the base layer and including a second bio resin based on biomass. A content of an inorganic additive included in the base layer 432 or the clear layer 433 may be 0.2 wt % to 0.6 wt % relative to a total resin weight.

According to an embodiment, the inorganic additive may include silica (Si) and zirconium (Zr).

According to an embodiment, a content of the silica of the inorganic additive may be 0.1 wt % to 0.4 wt % relative to a total resin weight, and a content of the zirconium may be 0.1 wt % to 0.2 wt % relative to a total weight.

According to an embodiment, when a content of each of a first bio-based resin of the base layer and a second bio-based resin of the clear layer is 20 wt % to 30 wt % relative to a total resin weight, a content of the inorganic additive in the base layer may be 2 wt % to 4 wt % relative to the total resin weight, and a content of the inorganic additive in the clear layer may be 0.2 wt % to 0.4 wt % relative to the total resin weight.

A washing machine 2 according to an embodiment of the disclosure may comprise a main body 610 including an opening formed in a front surface thereof, a cylindrical tub 630 disposed in the main body and formed to receive water, and a drum 640 rotatably disposed in the tub. An exterior material of the main body may include a frame 410 including a metal material, a primer layer 431 disposed on the frame, a base layer 432 disposed on the primer layer and including a first bio resin based on biomass, and a clear layer 433 disposed on the base layer and including a second bio resin based on biomass. A content of an inorganic additive included in the base layer 432 or the clear layer 433 may be 0.2 wt % to 0.6 wt % relative to a total resin weight.

According to an embodiment, the inorganic additive may include silica (Si) and zirconium (Zr).

According to an embodiment, a content of the silica of the inorganic additive may be 0.1 wt % to 0.4 wt % relative to a total resin weight, and a content of the zirconium may be 0.1 wt % to 0.2 wt % relative to a total weight.

According to an embodiment, when a content of each of a first bio-based resin of the base layer and a second bio-based resin of the clear layer is 20 wt % to 30 wt % relative to a total resin weight, a content of the inorganic additive in the base layer may be 2 wt % to 4 wt % relative to the total resin weight, and a content of the inorganic additive in the clear layer may be 0.2 wt % to 0.4 wt % relative to the total resin weight.

What is claimed is:

1. A refrigerator, comprising:
a main body;
a door connected to the main body and configured to open and close to respectively open and close the main body;
a storage compartment disposed in the main body to store food, wherein an exterior material of the main body includes:
a frame including a metal material,
a primer layer disposed on the frame,
a base layer disposed on the primer layer and including a first bio-based resin,
a clear layer on the base layer and including a second bio-based resin, and
wherein the base layer and/or the clear layer contain biomass and an inorganic additive.

2. The refrigerator of claim 1, wherein the inorganic additive includes silica (Si) and zirconium (Zr).

3. The refrigerator of claim 1, wherein
a content of the inorganic additive contained in the base layer is 0.2 wt % to 0.6 wt % relative to a total resin weight of the base layer, and/or
a content of the inorganic additive contained in the clear layer is 0.2 wt % to 0.6 wt % relative to a total resin weight of the clear layer.

4. The refrigerator of claim 2, wherein
a content of the silica of the inorganic additive is 0.1 wt % to 0.4 wt % relative to a total weight of the inorganic additive and a content of the zirconium of the inorganic additive is 0.1 wt % to 0.2 wt % relative to a total weight of the inorganic additive.

5. The refrigerator of claim 1, wherein a content of the first bio-based resin is 10 wt % to 100 wt % relative to a total resin weight of the base layer.

6. The refrigerator of claim 1, wherein a content of the second bio-based resin is 10 wt % to 100 wt % relative to a total resin weight of the clear layer.

7. The refrigerator of claim 1, wherein an average molecular weight (MW) of the first bio-based resin is 2,000 to 5,000 g/mol, and an average molecular weight (MW) of the second bio-based resin is 10,000 to 20,000 g/mol.

8. The refrigerator of claim 7, wherein
the base layer further includes a first petroleum-based resin and an average molecular weight (MW) of the first petroleum-based resin is 5,000 to 10,000 g/mol, and
the clear layer further includes a second petroleum-based resin and an average molecular weight (MW) of the second petroleum-based resin is 1,000 to 3,000 g/mol.

9. The refrigerator of claim 1, wherein
a content of the first bio-based resin is 20 wt % to 30 wt % relative to a total resin weight of the base layer and/or a content of the second bio-based resin is 20 wt % to 30 wt % relative to a total resin weight of the clear layer, and
a content of the inorganic additive in the base layer is 0.2 wt % to 0.4 wt % relative to the total resin weight of the base layer and/or a content of the inorganic additive in the clear layer is 0.2 wt % to 0.4 wt % relative to the total resin weight of the clear layer.

10. The refrigerator of claim 1, wherein
a content of the first bio-based resin is 55 wt % to 65 wt % relative to a total resin weight of the base layer or a content of the second bio-based resin is 55 wt % to 65 wt % relative to a total resin weight of the clear layer, and
a content of the inorganic additive in the base layer is 0.3 wt % to 0.5 wt % relative to the total resin weight of the base layer, and/or a content of the inorganic additive in the clear layer is 0.3 wt % to 0.5 wt % relative to the total resin weight of the clear layer.

11. The refrigerator of claim 1, wherein
a content of the first bio-based resin is 100 wt % relative to a total resin weight of the base layer or a content of the second bio-based resin is 100 wt % relative to a total resin weight of the clear layer, and
a content of the inorganic additive in the base layer is 0.4 wt % to 0.6 wt % relative to the total resin weight of the base layer and/or a content of the inorganic additive in the clear layer is 0.4 wt % to 0.6 wt % relative to the total resin weight of the clear layer.

12. The refrigerator of claim 1, wherein
a content of the first bio-based resin is 20 wt % to 25 wt % relative to a total resin weight of the base layer, and
a content of the second bio-based resin is 25 wt % to 30 wt % relative to the total resin weight of the clear layer.

13. The refrigerator of claim 11, wherein
the base layer and/or the clear layer include a curing agent, a defoamer, and a catalyst,
a content of the curing agent in the base layer is 5.0 wt % to 10.0 wt % relative to the total resin weight of the base layer and/or a content of the curing agent in the clear layer is 5.0 wt % to 10.0 wt % relative to the total resin weight of the clear layer,
a content of the defoamer in the base layer is about 0.2 wt % to 0.5 wt % relative to the total resin weight of the base layer and/or a content of the defoamer in the clear layer is about 0.2 wt % to 0.5 wt % relative to the total resin weight of the clear layer, and
a content of the catalyst in the base layer is about 0.5 wt % to 1.0 wt % relative to the total resin weight of the base layer and/or a content of the catalyst in the clear layer is about 0.5 wt % to 1.0 wt % relative to the total resin weight of the clear layer.

14. A home appliance comprising:
an exterior material including:
a frame including a metal material,
a primer layer disposed on the frame,
a base layer disposed on the primer layer and including a first bio-based resin, and
a clear layer disposed on the base layer and including a second bio-based resin,
wherein the base layer and/or the clear layer include an inorganic additive, and
a content of the inorganic additive in the base layer is 0.2 wt % to 0.6 wt % relative to a total resin weight of the base layer and/or a content of the inorganic additive in the clear layer is 0.2 wt % to 0.6 wt % relative to a total resin weight of the clear layer.

15. The home appliance of claim 14, wherein the inorganic additive includes silica (Si) and zirconium (Zr).

16. The home appliance of claim 15, wherein
a content of the silica of the inorganic additive is 0.1 wt % to 0.4 wt % relative to a total weight of the inorganic additive and a content of the zirconium of the inorganic additive is 0.1 wt % to 0.2 wt % relative to a total weight of the inorganic additive.

17. The home appliance of claim 14, wherein
a content of the first bio-based resin of the base layer is 20 wt % to 30 wt % relative to the total resin weight of the base layer and/or a content of the second bio-based resin of the clear layer is 20 wt % to 30 wt % relative to the total resin weight of the clear layer, and
the content of the inorganic additive in the base layer is 0.2 wt % to 0.4 wt % relative to a total resin weight of the base layer and/or a content of the inorganic additive in the clear layer is 0.2 wt % to 0.4 wt % relative to the total resin weight of the clear layer.

18. A washing machine, comprising:
a main body including an opening formed in a front surface thereof;
a tub in the main body and configured to receive water; and
a rotatable drum in the tub,
wherein an exterior material of the main body includes:
a frame including a metal material,
a primer layer disposed on the frame,
a base layer disposed on the primer layer and including a first bio-based resin, and
a clear layer disposed on the base layer and including a second bio-based resin, and
the base layer and/or the clear layer include an inorganic additive, and
a content of the inorganic additive in the base layer is 0.2 wt % to 0.6 wt % relative to a total resin weight of the base layer and/or a content of the inorganic additive in the clear layer is 0.2 wt % to 0.6 wt % relative to a total resin weight of the clear layer.

19. The washing machine of claim 18, wherein the inorganic additive includes silica (Si) and zirconium (Zr).

20. The washing machine of claim 19, wherein
a content of the silica of the inorganic additive is 0.1 wt % to 0.4 wt % relative to a total weight of the inorganic additive and a content of the zirconium of the inorganic additive is 0.1 wt % to 0.2 wt % relative to a total weight of the inorganic additive.
